(19) United States
(12) Patent Application Publication
(10) Pub. No.: US 2008/0057368 A1
(43) Pub. Date: Mar. 6, 2008

(54) Motion fuel cell

(76) Inventor: Richard Lee McElroy, Kamloops (CA)

Correspondence Address: RICHARD L. McELROY, 6177 GARDI RD., KAMLOOPS, BC, V1S-2A1, CA

(21) Appl. No.: 11/892,442

(22) Filed: Aug. 23, 2007

Related U.S. Application Data
(60) Provisional application No. 60/840,701, filed on Aug. 29, 2006.

(51) Int. Cl. H01M 8/02; H01M 2/02; H01M 8/04; H01M 2/08

(52) U.S. Cl. 429/26; 429/12; 429/34; 429/35

(57) ABSTRACT

A fuel cell system (with reference to a single cell arrangement) comprising means to provide for the motion-movement of an assembly comprised of an electrolyte sandwiched between an anode-electrode and a cathode-electrode; said motion-movement serving to accelerate electrochemical activity within the fuel cell by providing for accelerated reactant exposure to respective electrodes; including instant centrifugal water removal at the cathode-electrode surface; and boosted cooling to said anode-electrode; while offering accelerated (anti electroosmotic) moisturizing to the specific benefit of the anode side of a polymer-electrolyte.

### BACKGROUND OF THE INVENTION

1. Technical Field

The present invention relates to electrochemical fuel cells in general; of which, conventionally, the components of a single unit cell would include: an electrolyte sandwiched between an anode-electrode and a cathode-electrode and the interconnect material. The invention is particularly directed to accelerated electrochemical activity, improvements in reactant distribution, improved water management and removal at cathode, controlled anodic cooling; and with particular reference to polymer electrolyte membrane (PEM) fuel cells: increased humidification to the anode side of the PEM; and in any fuel cell, enhancing potential advantages and overcoming certain limitations that will benefit transportation and or stationary applications.

2. Background Art

There are well known various constructions and diverse types of fuel cells; and they are primarily classified by the type of electrolyte employed, which determines the fuel required, the temperature range of operation, if precious-metal catalysts are required; and in turn what applications they are most suited to. These varied types of fuel cells are continually being further developed; however, with certain advantages and limitations to any particular application.

Although aspects of the present invention may apply and offer advantage to various and diverse types of fuel cells, the conventional technology of a single PEM fuel cell and its electrochemical function is described in following detail:

The solid polymer electrolyte membrane (such as are available, for example, under the trademark Nafion) is interposed between an anode-electrode and a cathode-electrode, and receives (at the anode-electrode surface) a gaseous fuel (H2); and (at the cathode-electrode surface) an (02) oxygen-containing gas, i.e. oxygen gas or air. The reactants are distributed as evenly as possible over the respective electrode plates. The electrode plate surfaces facing the polymer electrolyte membrane (PEM) are provided with a layer of a precious-metal catalyst (usually platinum). An electrochemical reaction takes place at and between the said respective electrodes and the electrolyte. That is, hydrogen supplied to the anode-electrode is converted into hydrogen ions (H+cations) at the said electrode catalyst by the loss of electrons. The hydrogen ions (protons) are drawn to the cathode-electrode through the polymer electrolyte (which must be humidified). The electrons generated (released from the ions) during this oxidation process are drawn through an external circuit, thus producing direct current and usable electrical energy. As the electrons return, and are gained, at the reduction side of the fuel cell (i.e. the cathode-electrode) a complete circuit is resulted. Oxygen gas or air is supplied to the cathode-electrode; where, the hydrogen ions (i.e. protons, having come through the said electrolyte membrane), combine with the electrons (i.e. having returned from the external circuit) and with the said supplied oxygen to react with each other to produce water at the cathodic-electrode surface; completing the basic function of the fuel cell, i.e. the generation of electric power.

In order to supply the fuel (H2) and the oxygen gas (02) or air to the anode electrode and the cathode electrode respectively, conductive porous layers such as porous carbon paper sheets are commonly disposed on electrode surfaces. The porosity is needed to evenly distribute over the active electrode surfaces the respective reactants that are channeled by way of minutely engraved backing plates to areas of the respective electrode plates, but also to provide for the removal of the reaction product (water) at the reduction side.

With respect to PEM fuel cell technology, both advantages and limitations remain over other fuel cell types. However, according to the Department of Energy (DOE) the advantages over other fuel cell systems for producing economically and technologically viable electrical current load required by a light duty automobile that would adequately approach conventional performance and cost, at this stage of development, remains a PEM fuel cell; because they have fast start capability operating at lower temperatures. However, according to the DOE, solid oxide fuel cells, for example, are capable of generating more power, but require a substantial warm up period and operate at extremely high temperatures (1000 degrees C.), therefore are seen as auxiliary power units on heavy duty vehicles where systems may run for extended periods without frequent start and stop cycles. The disadvantages of the high operating temperatures i.e. slow start-up, shielding, high heat materials; however, offer a significant advantage over PEM fuel cells, in that the high temperatures eliminate the need for precious metal catalysts, reducing a significant cost, which present low temperature PEM systems must accept. Another advantage over the PEM fuel cell is that the electrolyte is a solid, hard nonporous ceramic material, which allow for greater pressure differences between the anode and cathode chambers; as well, allowing for greater diversity in cell design. Direct Methanol Fuel Cells (DMFCs), according to the DOE, seem to be well suited for portable power applications where the power requirements are low and the cost targets are not as stringent as for transportation applications. However, DMFCs offer advantage over PEM systems in that methanol is a higher density fuel than reformed hydrogen, allowing for greater onboard storage of consumable energy and therefore greater range in transportation applications. As well methanol is a liquid fuel, offering the said transportation application the advantage of present dispensing infrastructure, i.e. gas pumps, tank storage and present delivery systems. DMFCs are fueled by pure methanol, entrained with water-steam, supplied at the anode.

As referenced above, the low energy density of pure hydrogen, as a fuel, presents a problem for a PEM fuel cell fed by pure hydrogen, when concerning on-board fuel supply and range in transportation applications. The reforming of fuel, on-board, i.e. extracting pure hydrogen from hydrogen rich fuels for use in the fuel cell, is not a possible option at present because reformers require high heat to function; and conventional low heat PEMs do not provide the heat by-product needed. This leaves the option of increasing the heat out-put of a PEM fuel cell to be able to reform its own pure hydrogen supply from other fuels delivered on-board; potentially, even liquid hydrocarbons could be reformed; in that catalysts more resistant to carbon monoxide (CO) contamination (i.e. platinum/ruthenium catalysts) are being explored. Another, perhaps favored option being advanced is to compress pure hydrogen at great density (as much as 10,000 psi) in, on-board, high pressure composite fuel tanks. Such is presently being developed, tested and showing some promise; however, at certain cost.

Further, with regard to PEM fuel cells, according to the DOE, the cost, performance and durability of fuel cell power systems must be improved to be competitive with conventional internal combustion engine power plants. One of the major contributing factors to cost at this time remains precious metal loading at the electrodes (particularly at the cathode). A higher heat operating PEM would increase electrochemical activity at the electrodes and diminish precious metal catalyst requirements; however, a greater need to humidify the Polymer membrane would be required; not only because of increased dehydration due to exothermic heat, but because of the increased ionic current flow. The DOE states progress has been made in developing fuel cell membranes that are capable of operating at 120 degrees C., or above, toward lessening this problem; however, greater humidification remains an issue at the anodic side of the polymer membrane. This drying of the membrane (caused by both exothermic heat, and electroosmotic travel of water molecules being carried by H+cations (protons) across the polymer membrane) causes the condition of fuel side membrane dehydration to form at the anode-side of the electrolyte preventing ions (protons) from passing through the membrane to the cathode. With reference to another variation of prior art in U.S. Pat. No. 4,678,724, a relevant fact, pertaining to a specific benefit of the present invention, is stated: “ . . . drying of the hydrogen side of the membrane may be substantially reduced, even at high cell densities and high battery output, by cooling the hydrogen side of the membranes sufficiently to establish a temperature gradient which causes back migration of water from the cathode to the anode side to alleviate drying.” Although this cooling and resultant moisturizing has proven a benefit to the PEM, it has not been fully realized in prior art with respect to the improvements in the present invention; and has therefore only offered a component of membrane hydration at the anode. In addition, it has been a practice, particularly in PEM fuel cell technology, to entrain water into the fuel supply to help rehydrate the membrane; however, it is found that over hydrating this way can cause a moisture film to build up at the anode-electrode surface; hindering fuel contact with the said electrode, limiting the amount of water that can be entrained with the fuel to benefit the said membrane.

Another area needing improvement within conventional fuel cell systems, of which the present invention pertains, is the un-even “mal-distribution” of fuel at the anode, causing a condition known as “hot spots” that diminish reactant fuel diffusion performance at the anode side. This problem is aggravated, in prior art, by the high cost and by the limited performance and capability of minute and complex flow-channels, by necessity, engraved into carbon backing plates (used in flat plate fuel cells) to distribute reactant to electrodes (and to carry by-product water away) within a closed pressure delivery system.

Another cost and performance issue, of which the present invention pertains, is the air management required in conventional systems. The DOE states: “Pressurization of fuel cells will result in higher power density and lower cost.” This statement would largely be directed to water management (dehumidifying the cathode) and with regard to the inherent slow kinetics at the cathode; noted by the DOE, to be as much as a hundred times slower than at the anode. In a conventional closed pressure system, air (02), as stated by the DOE, should be delivered to the cathode at pressures of at least 3 atmospheres. However, the parasitical drag, cost, bulk, capacity and reliability of the compressors being developed, to provide such, remain issues. For example, the durability of such compressors depend on effective lubrication for friction and wear reduction in critical components, which according to the DOE, the lubricants needed, with respect to present technology, can contaminate and poison the electrodes in the fuel cell stack. Although critical components are being developed, the durability, cost, bulk, capacity and the parasitical power drag on the overall system output, remain issues.

Water removal at the cathode-electrode surface in conventional pressured stack systems has been largely attempted by means of high pressured air, forced at the cathode side, such not only to provide (02) reactant (as described above to increase reaction “kinetics”) but to carry water out of the described convoluted and minute flow-channels, sculpted within the high pressure system. Because of the above limitations and problems with specialized high compressor systems to accomplish this “dehumidification of the cathode” within such high pressure systems and the resulting cost and performance limitations of the minute flow-channels, there remains a continuing need for further improved systems that will offer effective water removal from the cathode while offering any desired level of (02) delivery. It is known, with the desired higher density output of any fuel cell system comes the inherent problem of staying ahead of an over humidified and moisture ridden cathode. Therefore, efficiently removing water instantly as it is formed, and simultaneously at the entire cathode-electrode surface, is essential in any effective water management effort; thus preventing the film build-up and flooding (dead-spots) that occur at cathode-electrode surfaces.

Such efforts will offer the benefit of smaller systems i.e. incorporating less sq. area of active electrode surface; and therefore, smaller requirement for precious metal loading for catalyst; and therefore providing greater productive output, at less overall cost.

### SUMMARY OF THE INVENTION

A principle object of the invention is to provide a new concept in a fuel cell system which makes it possible to achieve optimum reactant gas diffusion performance; excellent water management and removal performance; controlled cooling of fuel side electrode; and offering increased humidification to the benefit of the fuel side of a polymer electrolyte membrane (PEM).

The invention as it pertains to PEM fuel cell technology will provide a novel mechanism and function for the improved (and accelerated) reactant distribution within the fuel cell; which will substantially reduce the occurrence of harmful ‘hotspots’ (caused by uneven or mal-distribution of fuel) or the moisture ridden ‘dead spots’ in active electrode surface areas; while increasing overall electrochemical activity over a given square area of said active electrode surfaces, per second of operation. As well, the exothermic heat generated at the anode may be maximized for greater electrochemical activity while minimizing the negative accompanying drying effect on the fuel-side of the polymer membrane in a PEM fuel cell. Further, the benefits resulting from the novel function of the invention promise to reduce precious metal catalyst requirements in a PEM fuel cell system.

It will be conceivable certain aspects of the invention may also provide benefit to other fuel cell technologies that comprise an anode, electrolyte and cathode in relationship thereof. For example: in a solid oxide fuel cell (SOFC) system the novel cooling capacity of the present invention may offer benefits at the operating stage of a SOFC system, to hold an optimum temperature; and at the start up stage, offer an accelerated, therefore faster warm-up; which may be of use in transportation applications. Such a system and others, promise to reduce or eliminate precious metal catalysts; and or, provide for the use of a variety of fuels; including fuels which may not involve the reforming of hydrogen, such as direct methanol fuel cells (DMFC), etc.

The present invention (applied to a PEM) will forward the advantages of more effective water removal, better reactant distribution, greater anodic-side cooling and hydration, and all the advantages of pressure density at the cathode electrodes, but without the disadvantages of providing for compression pressure in a fuel cell system. An embodiment of the invention promises to largely if not completely replace the costly high pressure delivery compressor systems and the minute, limited channeling means within contemporary PEM fuel cell plate stacks that require costly construction to accommodate severe pressure delivery (such technology at this time being driven by transportation applications) with what can essentially be the unlimited delivery of reactant to electrode surfaces by way of moving the electrode surfaces at any desired velocity, through the reactant, at low or ambient pressures, rather than by way of said limited high compression delivery technology and the severe parasitical power drag (including bulk, weight and expense) attempting to thrust-force reactant into minute and convoluted flow channels, normally engraved into carbon current collectors in flat plate fuel cell stacks, to be brought into contact with electrode surfaces; such, higher compression delivery also being needed to provide for any water removal and dehumidification at the moisture ridden cathode.

To further explain, according to the preferred embodiment of the invention, reactant contact density per square area of active electrode surface is achieved by the (theoretically unlimited) velocity of rotating cylindrically shaped electrodes, at low or ambient pressures, rotating (traveling) through reactant; i.e. fuel and (02) being evenly distributed (as if by thrust) over high speed rotating (traveling) electrode surfaces; rather than attempting to achieve, in a contemporary pressure stack, any equivalent (or less) delivery of reactant by thrust, forcing reactant through minute channels (creating severe and unnecessary density) in a closed high pressure static stack system. In other words, it is possible to spin an electrode faster, according to the preferred embodiment of the invention, than to compressor-force reactant through a contemporary static system, to create greater contact opportunity per second between an electrode surface and reactant. The benefits do not end there, particularly when the removal of water at the cathode, and cooling at the anode, is more effectively accomplished by the same high speed rotation.

In addition, it should be noted with reference to the above, that contemporary compressor capabilities are not able to produce ‘theoretically unlimited’ compression of reactant; i.e. air (02) reactant, to meet any ‘theoretically unlimited’ fuel (H2) reactant, at near or greater pressures. The preferred embodiment of the present invention will provide opportunity for the unrealized benefits of ‘unlimited’ provision of reactant to electrodes (by way of high speed traveling electrodes); so far only attempted by the limited thrust-force of contemporary compressor capabilities.

With reference to the above, it has been noted in PEM fuel cell systems, that pressure differences between the anodic oxidation area (fuel side) and the cathodic reduction area (02 side) of the fuel cell should be slightly different, with the cathodic area being at the higher pressure for better electrochemical result. However, because performance at the cathode is much slower than performance at the anode, there is a benefit to increasing kinetics at the cathode relative to the anode. The DOE states, concerning electrode performance: “kinetics at the cathode is ˜100 times slower than at the anode.” The effect of rotating the electrodes at velocity, according to the invention, will allow the above, ideal, slight pressure differences (necessary, for a polymer electrolyte membrane to avoid stress or rupture) even while accessing any desired provision of (02) at the cathode electrode surface. At the anode side, the over fed cathode is allowing for better fuel hunger, as it is known that overall fuel cell performance is sensitive to oxygen depletion (reduced air (02) to electrode contact (pressure) in contemporary static stacks) at the cathode.

In operation, according to the preferred embodiment of the invention, the anode, electrolyte and cathode or (AEC assembly) is powered to rotate as one unit (with a plurality of like units) at a velocity that will specifically benefit the anode, electrolyte and the cathode to increase overall electrochemical reaction and performance. More specifically the anode and cathode are constructed to permanently sandwich an electrolyte; and are conceived to be a separately manufactured and distinct concomitant (or bonded) assembly unit; and an easily replaceable part within a plurality of like units housed within a fuel cell system; theoretically recycled for reclamation of any catalyst material and remanufactured. The separately and specially manufactured AEC assembly will offer advantage over manufacturing processes in prior art; in that, the intricate relationship of the anode and cathode materials sandwiching the PEM can be accomplished by processes and techniques that would not be economically practical in a contemporary static plate system assembly process.

It is conceivable according to the invention that the cathode electrolyte and anode (AEC assembly) in an alternative embodiment of the invention may be constructed as generally cylindrical or tubular shapes, however in various diameters, in order to concentrically place a multiple of other like members, one within another, each said member sharing an axis center, the said differing diameter or radius of each said member allowing an annulus space of which a stationary fuel and cooling delivery, as according to the invention, may be positioned and so shaped so as to be disposed within each said annulus space between each said AEC assembly member providing fuel reactant and cooling delivery means as according to the invention. The plural and combined rotation of each concentrically positioned AEC assembly member may well be achieved through common shared rigid-fixed attachment at the outer edge or lip area of each said AEC member to a common motion-movement mechanism preferably engaged at one or the other end of the concentrically arranged plurality of said AEC assemblies. Additionally, a multiple array of said concentrically arranged pluralities may share a single motion-movement drive mechanism, a single housing and or a supporting infrastructure, a single source of reactant and cooling medium, and share a common manifold and entry and exit apertures of the same, in a single system.

It is also conceivable according to the invention that the cathode, electrolyte and anode or (AEC assembly) in another differing embodiment of the invention, could be constructed as a rotating (or otherwise moving) plane, plate or disk shaped surface member wherein a plurality of such are fixed at their axis center on a rotating shaft (or alternatively mounted to rotate around a shaft) and spaced there on, allowing for a stationary reactant delivery means, such means being a plate or disk shape and in like plurality, positioned between each moving AEC assembly to provide for reactant ducting and delivery and heat exchanging cooling ridges or channeling as according to the invention; the said stationary plane, plate or disk shape of the reactant delivery and cooling means would provide the identical function as the stationary fuel and cooling bar or (FC bar) further identified below in the detailed embodiment of a single cylindrical cell. The rotating of the said plane, plate or disk shaped (AEC assembly) resulting in reactant contact density, water removal and electrode cooling to each said assembly so arrayed.

However, to continue, with regard to the single cylindrical embodiment, the said AEC assembly, at one end is attached (fastened) in a removable connection (which may be a (locking) threaded male, female relationship) to a permanent receptacle that is connected to a stationary housing by bearing(s) and powered to rotate, at low resistance, and little parasitical power drag from the systems electrical output (or charge to battery) during operation and by battery at start up.

According to the preferred embodiment of the invention, the said AEC assembly, being a cylindrically manufactured part, rotates around a stationary axis; at such axis, fuel and cooling is provided to the anode inner surface through a stationary fuel delivery and heat exchanging cooling bar that the AEC assembly rotates in axis around. The annulus between the surface of the said stationary fuel and cooling bar or (FC bar), and the anodic inner surface of the said rotating AEC assembly is the oxidation area of a PEM fuel cell system. The anode is benefited by the rotating movement and velocity of the AEC assembly; in that, such rotation is providing for more efficient and even fuel dispersing and distribution; and greater fuel contact opportunity, per second, at the entire active surface of the anode; alleviating the condition known as “hotspots” at the anode.

The rotation of the anode surface, i.e. AEC assembly, according to the invention, will provide opportunity for greater moisturizing to the anode side of the electrolyte-membrane by way of the rapid and direct cooling of the anodic surface. As the rotating anodic surface (or AEC assembly) is passed over each cooling ridge (or alternatively passed over cooling ducting disposed within wall) of the said stationary fuel and cooling bar (FC bar) heat is rapidly removed from the traveling anodic surface, where it is generated, by heat exchange (radiator) outside the system. This rapid and efficient heat removal, through the said FC bar, will reduce electroosmotic travel (moisture loss) from the anode, through the electrolyte, to the cathode. And by such efficient and rapid cooling will serve to draw essential moisture back from the cathodic side, to the anodic side of the electrolyte, for continual hydration (moisturizing) of the PEM. Such back diffusion of water has been shown to provide some anode-side rehydration in prior art. However, according to the invention, the high velocity rotation of the AEC assembly will offer greater, more direct and rapid cooling; and therefore more rehydration to the PEM at the fuel side, even in higher current density operation.

As well, in contributing to further humidification of the PEM at the anode, it is customary, in contemporary PEM fuel systems to entrain water into the fuel stream to provide moisture vapor to rehydrate the fuel side of the membrane; although this hydration has not been sufficient, alone, in higher current density operation, to counter the transport of water molecules that each proton carries across the membrane (during oxidation at the anode side), it has been a contributing factor in prior art to moisturize the membrane. However, the amount of water which can normally be fed into the fuel stream is limited; that is, with too much water vapor entrained into the fuel, a water film tends to form over the anode electrode surface preventing the fuel from a fully exposed active surface. The high velocity rotation of the AEC assembly will serve to significantly diminish the negative effects of any necessary hydration of the fuel; in that, the build up of water film that would tend to form in prior art systems would be more evenly and instantly dispersed over the entire anode-electrode surface by centrifugal motion; to the extent more water vapor may be able to be fed into the fuel stream with less negative effect; or less water vapor having better effect.

A further benefit will occur as the gaseous fuel flow travels between the cooling ridges along the length of the FC bar and the said fuel is cooled by the said ridges; while warmed at the area between the ridges, which is the oxidation area relating to the traveling anode-electrode; such, providing for some condensation and therefore an additional humidifying effect within the oxidation area; to the specific benefit of a PEM fuel cell system application.

The annulus or space between the cathodic surface of the said rotating assembly and the inside wall of the stationary housing (or cathode wall) is the reduction area of the fuel cell system. With reference to the above, the rotating movement and velocity of the said AEC assembly will offer further specific advantage and benefit to the cathode side of the said assembly. By means of centrifugal force, the rotating surface of the cathode will throw off excess water instantly, as it is formed, preventing moisture film build up and any resulting “dead spots” over the entire cathodic electrode surface. In addition, such rotating velocity will serve to keep the cathodic reduction area dehumidified; and to increase reactant, (02, or ambient air) contact opportunity and availability at the entire active surface area of the cathodic electrode, per second of operation; such providing for a very effective and efficient cathodic water separation and removal system.

It is additionally conceivable that alternative motion-movement (other than the continuous rotation movement around an axis in one direction or the other, so far described in the preferred embodiment) may be effective in providing for reactant contact density, water removal and electrode cooling. Such alternative motion-movement may include an oscillating, rapid to and fro, or similar vibration (micro) motion-movement; or a reciprocating rapid back and forth, or up and down motion, occurring along a straight line, or a similar vibration (micro) motion-movement; or an alternating or combination of such movements resulting in a gyration or similar vibration (micro) motion-movement. The various alternative motion-movements will be applicable to a cylindrically shaped AEC assembly and or plane, plate or disk shaped AEC assemblies.

With reference to the above stated alternative motion-movements having a to and fro, or a back and forth, or up and down, or any alternating or combination of said motion-movements or resulting gyro motion-movement, may incorporate the AEC assembly unit to be mounted at and or supported by a motion or shock absorbing mount(s) directly or indirectly fixed to a generally stationary housing, and or sub-housing and or otherwise supporting infrastructure. The said mount(s) being a part or component having a give and take function capability allowing for any of, or a combination of, said alternative motion-movements.

It is further conceivable, that the oxidation and or reduction chamber area(s) in such an alternative embodiment may partake in said motion-movement(s) if said chamber area(s) are affixed to said motion-moving AEC assembly unit; such a further alternative embodiment may offer some advantages over static prior art; however, will not offer all the advantages of the preferred or other embodiments of the invention.

The above and other objects, features and advantages of the invention will become more apparent from the following description when taken in conjunction with the accompanying drawings; in which the preferred and other embodiments are illustrated.

### BRIEF DESCRIPTION OF THE SEVERAL VIEWS

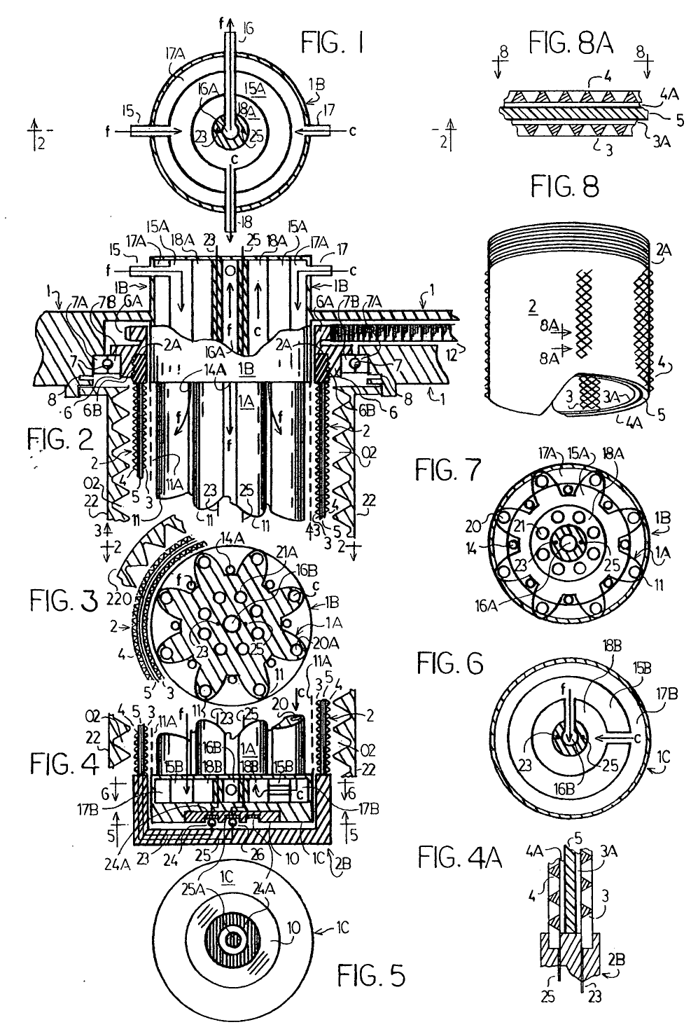

FIG. 1 is a top sectional view, looking down into the main manifold 1B with the ceiling (cap) cut away; as well, the floor of the main manifold 1B and the various inlet-outlet apertures communicated there are not shown; the arrangement of these various apertures are instead shown in FIG. 7, for sake of clarity. FIG. 1 is taken along lines 1-1 in FIG. 2.

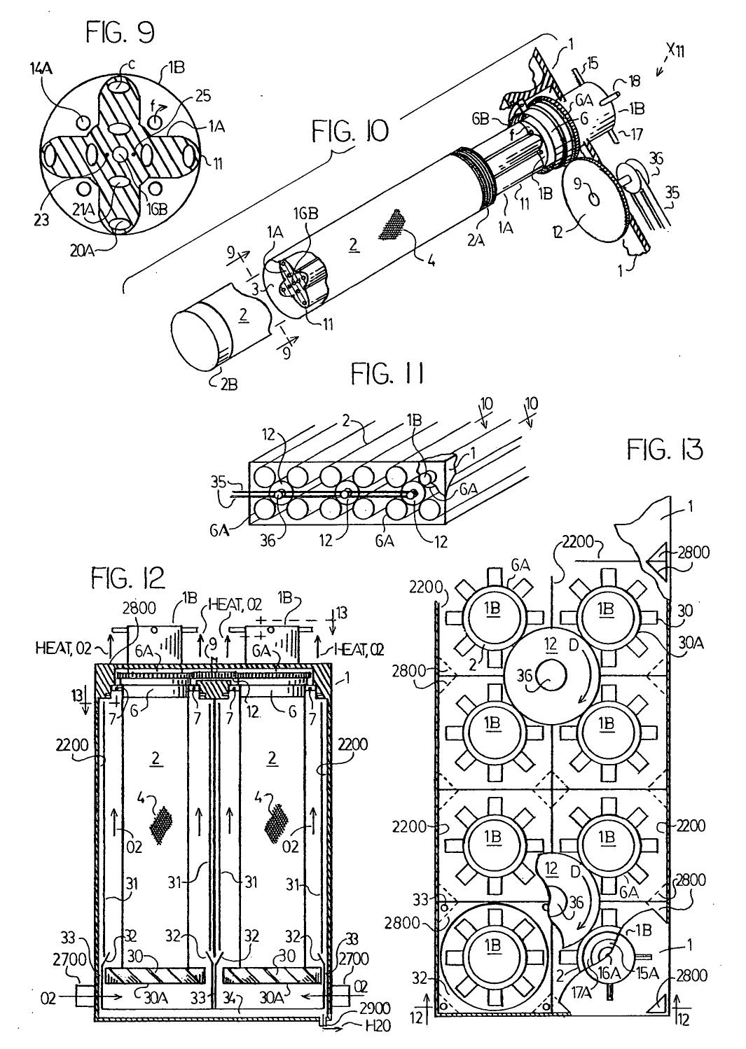

FIG. 2 is a side, partially hatched, sectional view of the main manifold 1B and the connected fuel and cooling delivery bar (FC bar) 1A; such being the (upper) connected end of the fuel cell unit; taken along lines 2-2 in FIG. 1; and along lines 2-2 in FIG. 3.

FIG. 3 is a cross sectional view, looking up at the FC bar from a mid-section cut away; taken along lines 3-3 in FIG. 2.

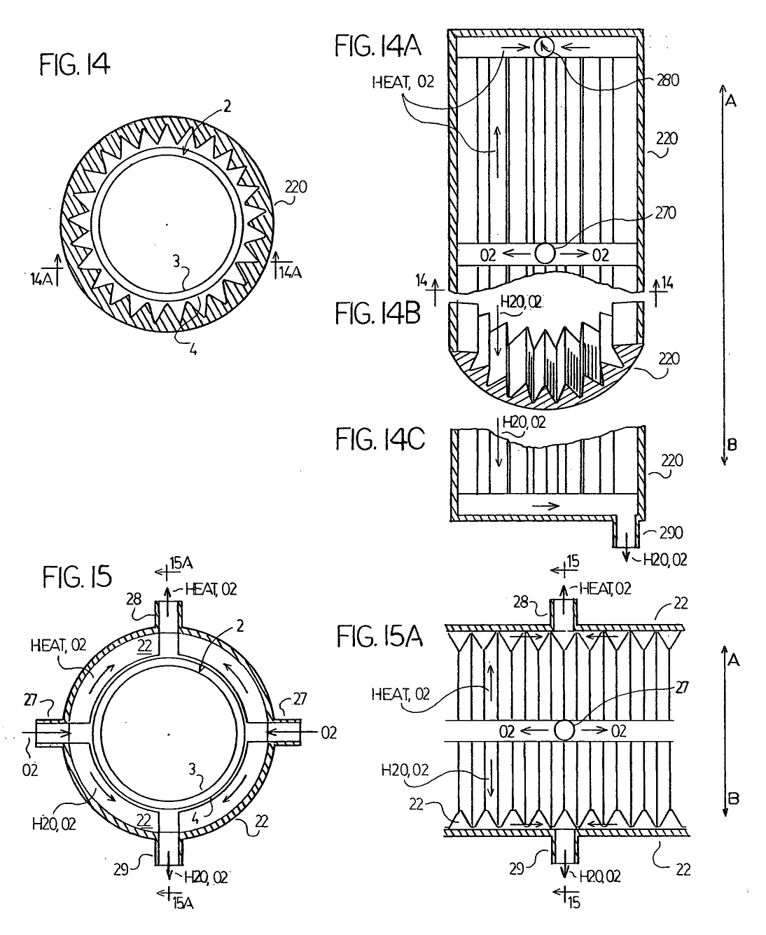

FIG. 4 is a side partial sectional view of the return (lower) end portion fuel cell unit taken along the same line of view as FIG. 2.

FIG. 4A is a magnified sectional view showing the anode, electrolyte and cathode assembly (AEC) assembly 2 and the electrical lead circuits 23 and 25 shown connected to the anode and cathode electrodes at the base wall end portion 2B of the AEC assembly 2. FIG. 4A is taken along the same line of view as FIG. 4.

FIG. 5 is a bottom view, looking up at the return manifold 1C and the electrical conductive track thereof; and is taken along lines 5-5 in FIG. 4. FIG. 5 depicts the flip side of FIG. 6.

FIG. 6 is a top sectional view, looking down into the return manifold 1C; however, not shown is the ceiling comprising the various outlet apertures that pour into said return manifold 1C various concentric chambers; the communicating apertures are seen in FIG. 3. FIG. 6 is taken along lines 6-6 in FIG. 4.

FIG. 7 is a top sectional view, looking down into the main manifold 1B, taken along the same line of view as FIG. 1. The depiction of the outline shape of the fuel and cooling delivery bar (FC bar) 1A (shown by solid line) would actually not be visible through (this side of) the floor of the main manifold 1B, but is shown for better clarity of the communicational relationship between the main manifold 1B and the FC bar 1A.

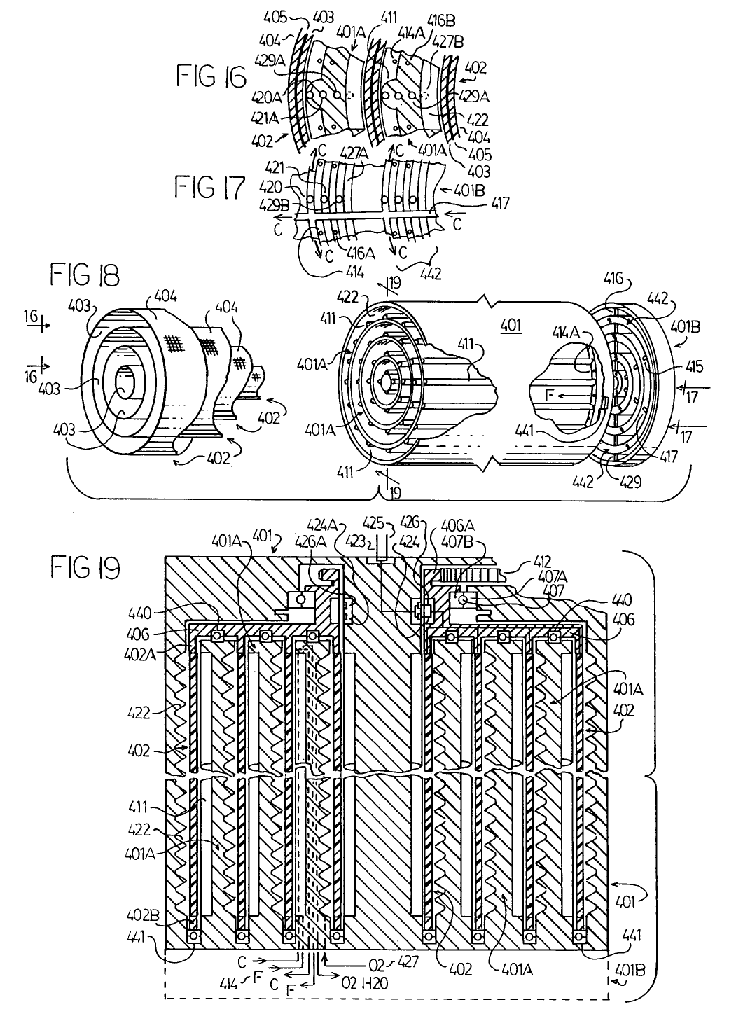

FIG. 8 is a perspective view of the anode, electrolyte and cathode assembly (AEC) assembly 2, taken nearly along the same line of view as FIGS. 2, 3 and 4 (except for a slight tilt in the perspective view); however, the AEC assembly 2 is shown in a different scale than is shown in FIGS. 2, 3 and 4.

FIG. 8A is a magnified sectional view of the AEC assembly 2 reactant wall; taken along lines 8A-8A in FIG. 8.

FIG. 9 is a cross sectional view of the FC bar 1A, taken along the same line of view as FIG. 3; however, exampling an alternative design than what is reflected in FIG. 3.

FIG. 10 is an exploded perspective view of the over all single rotary motion fuel cell unit, shown in smaller scale. However, exampling the alternative design of the FC bar 1A as depicted in FIG. 9. FIG. 10 is taken along lines 10-10 in FIG. 11.

FIG. 11 is a schematic perspective view, exampling an array of fuel cell units arranged for single source power rotation. FIG. 11 is taken along the line of view represented by broken arrow marked 11 in FIG. 10.

FIG. 12 is a side partial sectional view of an alternative cathodic embodiment, and (02) chamber wall 2200 (as opposed to 22 and 220 described in differing embodiments), involving propulsion of 02 reactant; and taken along lines 12-12 in FIG. 13.

FIG. 13 is a top multi-level sectional view of the same alternative embodiment that is shown in FIG. 12; however, certain details shown in FIG. 12 are only included in lower sectional portions of FIG. 13, for sake of clarity. FIG. 13 is taken along lines 13-13 in FIG. 12.

FIG. 14 is a gravitational-top, sectional view of another alternative embodiment of the cathode (02) chamber wall 220 (as opposed to 22 and 2200 described in differing embodiments); taken in the same direction as shown in FIG. 3; and taken along lines 14-14 in FIG. 14A.

FIG. 14A is a gravitational-side, sectional view showing the same alternative embodiment of the cathode chamber wall 220 as is shown in FIG. 14; taken along lines 14A-14A in FIG. 14. The arrows marked (02) and (Heat, 02) show the direction of vaporous flow and top outlet 280. The arrows marked A-B indicate the gravitational-top (A) and the gravitational-bottom (B); as specifically related to FIGS. 14A, 14B and 14C.

FIG. 14B is a perspective sectional view, taken nearly along the same lines as FIGS. 14A and 14C (except for a slight tilt for perspective), depicting the middle portion of the cathode wall 220 as related to FIGS. 14A and 14C.

FIG. 14C is a sectional view and a continuation of, and taken along the same lines as FIGS. 14A and 14B, depicting the bottom portion of the cathode chamber wall 220; the arrows marked (H20, 02) show the direction of liquid flow and bottom outlet 290.

FIG. 15 is a gravitational-side, sectional view of yet another alternative embodiment of the cathode chamber wall 22 (as opposed to 220 or 2200 described above); taken in the same direction as such depicted in FIGS. 2 and 4; and taken along lines 15-15 in FIG. 15A. The arrows marked (02), (heat, 02) and (H20, 02) depict the direction of flow of such.

FIG. 15A is a sectional view showing the same embodiment of the cathode chamber wall 22, as is shown in FIG. 15; and is taken along lines 15A-15A in FIG. 15. The arrows depicted show the in-out direction of (02) reactant or air and heat vapor and water flow as related to FIG. 15. The arrows marked A-B indicate the gravitational-top (A); and the gravitational-bottom (B); as specifically related to FIGS. 15 and 15A.

FIG. 16 is a magnified cross sectional view of a further alternative embodiment, being a multiple concentric configuration; taken along lines 16-16 in FIG. 18.

FIG. 17 is a magnified cross sectional view of the concentric manifold of same embodiment; showing a portion of the multiple plenum chambers feeding and receiving different mediums; only cooling medium delivery is shown, for clarity, traveling from one concentric chamber to another. FIG. 17 is taken along lines 17-17 in FIG. 18.

FIG. 18 is an exploded perspective view of the larger over all multiple concentric configuration, including the said concentric manifold and the concentric AEC assembly separated from the housing.

FIG. 19 is a sectional view of the larger over all said multiple concentric configuration; however, the concentric manifold is left out, but for an outline, for clarity. FIG. 19 is taken along lines 19-19 in FIG. 18.

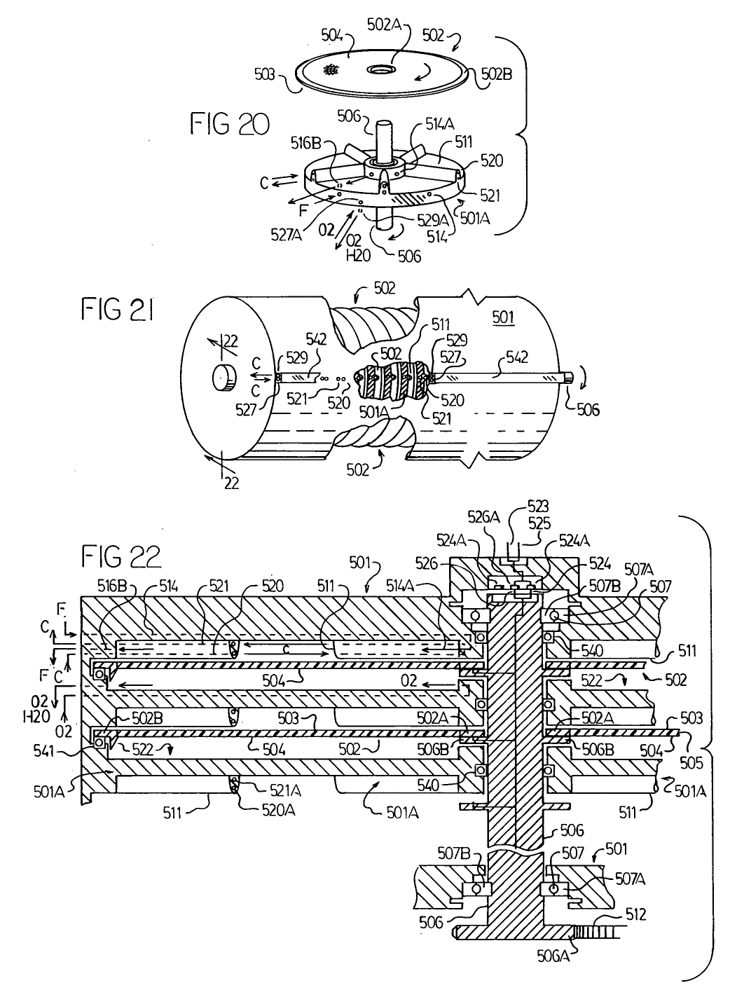

FIG. 20 is an exploded partial cross sectional perspective view of yet another differing embodiment; utilizing a disk or plate shaped AEC assembly.

FIG. 21 is a perspective partially hatched view of the larger over all multiple disk or plate configuration.

FIG. 22 is a partial sectional view of same multiple disk or plate configuration; taken along lines 22-22 in FIG. 21.

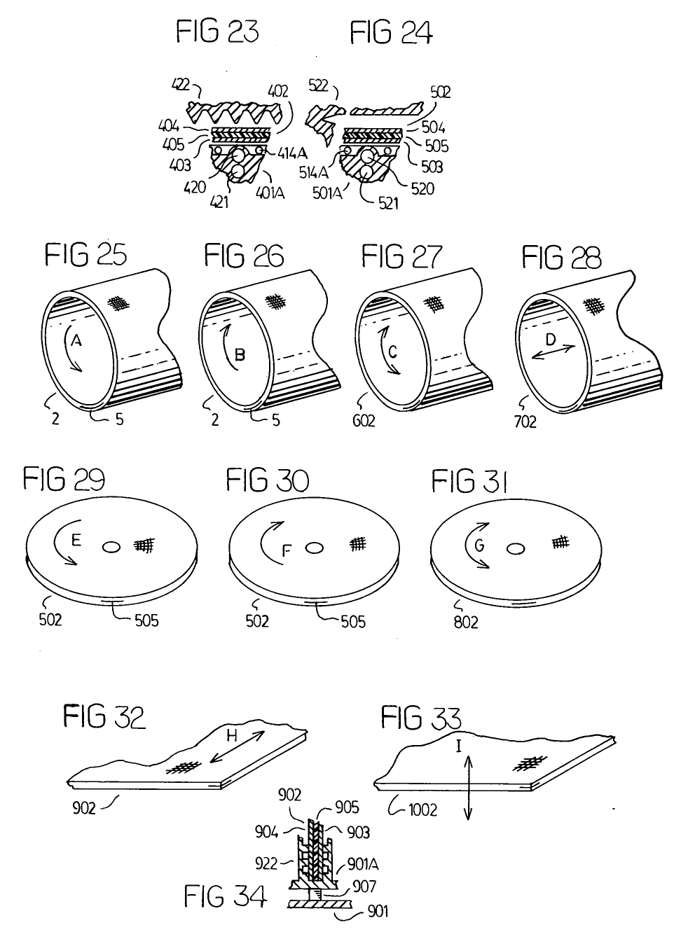

FIG. 23 is a magnified partial sectional view of a cathode wall as it may relate to a continuous rotating cylindrical or tubular shaped AEC assembly.

FIG. 24 is a magnified partial sectional view of a differing cathode wall as it may relate to a continuous rotating plate, plane or disk shaped AEC assembly.

FIG. 25 is a partial perspective view of a cylindrical, tubular shaped AEC assembly; the arrow depicted marked (A) shows the direction of a continuous rotating motion-movement.

FIG. 26 is a partial perspective view of a cylindrical, tubular shaped AEC assembly; the arrow depicted marked (B) shows the direction of a continuous rotating motion-movement.

FIG. 27 is a partial perspective view of a cylindrical, tubular shaped AEC assembly; the arrow depicted marked (C) shows the direction of an oscillating motion-movement and or micro-oscillating or vibration motion-movement.

FIG. 28 is a partial perspective view of a cylindrical, tubular shaped AEC assembly; the arrow depicted marked (D) shows the direction of a reciprocating motion-movement and or micro-reciprocating or vibration motion-movement.

FIG. 29 is a perspective view of a disk or plate shaped AEC assembly; the arrow depicted marked (E) shows the direction of a continuous rotating motion-movement.

FIG. 30 is a perspective view of a disk or plate shaped AEC assembly; the arrow depicted marked (F) shows the direction of a continuous rotating motion-movement.

FIG. 31 is a perspective view of a disk or plate shaped AEC assembly; the arrow depicted marked (G) shows the direction of an oscillating motion-movement and or a micro-oscillating or vibration motion-movement.

FIG. 32 is a partial perspective view of a plane, disk or plate shaped AEC assembly; the arrow depicted marked (H) shows the direction of a reciprocating motion-movement and or a micro-reciprocating or vibration motion-movement.

FIG. 33 is a partial perspective view of a plane, disk or plate shaped AEC assembly; the arrow depicted-marked (I) shows the direction of a reciprocating motion-movement and or micro-reciprocating or vibration motion-movement.

FIG. 34 is a magnified partial sectional view of a single cell AEC assembly with attached (fixed) oxidation and reduction chambers, incorporating a motion or shock absorbing mount fixed between a motion-moving AEC assembly and a generally stationary housing or supporting infrastructure.

### DETAILED DESCRIPTION OF THE INVENTION

In referring to first 3 drawing pages (numbered: 1 of 6, 2 of 6 and 3 of 6), and in particular to FIGS. 1 and 2; the stationary main structure 1 is the structural support and outer wall of the system. The stationary structure 1, supports (in a fixed position) the fuel and cooling delivery bar (or FC bar 1A), and the end manifold units 1B and 1C which are the connected end portions and part of the said FC bar 1A. The extended stationary structure 1, in addition, supports a greater plurality of (FC bar 1A, 1B and 1C) fuel cell units; including a plurality of powered gear systems 12, which engage the rotary drive mechanism of each fuel cell unit.

FIG. 1 is taken along lines 1-1 in FIG. 2, and is a top view (relative to FIG. 2) of the main manifold 1B; comprising: the fuel-reactant, or fuel (F), entry valve 15; and fuel exit valve 16; and the coolant-medium, or coolant (C), entry valve 17; and coolant (C) exit valve 18; and the concentric chambers of each, respectively, 15A, 16A, 17A and 18A; the said concentric chambers allow a radius of inlet and outlet openings for fuel stream (F) and cooling medium (C) to be dispersed about the (respective, outside and or inside) radius of the FC bar 1A; for travel down the length of the FC bar 1A, and back again. Each concentric chamber is a separate walled and sealed plenum within the main manifold 1B shown by concentric lines depicted in FIGS. 1 and 7.

In FIG. 2, the said main manifold 1B is depicted in a side view, with the walls of each chamber 17A, 15A, 18A and 16A revealed in a partial sectional cut away of the main manifold 1B. FIG. 1, as shown, is the same top view of the interior of the main manifold 1B, as is FIG. 7; however, FIG. 7 focuses on the various apertures of inlets and outlets 14, 16A, 20 and 21 that communicate fuel and cooling to and from the main manifold 1B concentric chambers 15A, 16A, 17A and 18A for delivery of fuel (F) and coolant (C) to the FC bar 1A, and through the correlated concentric chambers 15B, 16B, 17B and 18B, respectively, of the return manifold 1C (depicted in FIG. 4 and FIG. 6) and back again to the main manifold for exit; i.e. exit valves 16 and 18. (The various inlet or outlet apertures 14, 20 and 21 that are shown in FIG. 7, are not shown in FIG. 1, for the sake of clarity. In addition, the related inlet or outlet apertures 14A, 20A and 21A that are shown in FIG. 3, are not shown in FIG. 6, for sake of clarity. It may be noted, as well, 14, 16A, 20 and 21 are in pressurized communication with 14A, 16B, 20A and 21A, respectively).

The fuel (F), stored outside the fuel cell, enters the main manifold 11B at the fuel entry 15, shown in FIGS. 1 and 2. The fuel (F), following the direction of arrow marked (F), pressurizes the fuel inlet chamber 15A and forces the Fuel stream (F) through the fuel feed inlet apertures 14, provided in the floor of (and disposed within) the concentric circular chamber 15A; the said inlet apertures 14 are shown in FIG. 7. The concentric construction of this chamber allows a radius of distribution openings 14, for the fuel stream (F). When the fuel stream (F) passes through inlet apertures 14, it emerges from the other side of the floor of 15A and out outlet apertures 14A, as indicated in FIG. 2, following the direction of fuel flow arrows marked (F); note, 14 and 14A are opposite openings of the same bore (outlet apertures 14A, and fuel flow arrow (F), is also seen in FIG. 3 which is a sectional, bottom view relative to FIGS. 2 and 7).

The fuel flow (F) is now released to the anodic oxidation area which exists (with reference to FIGS. 2, 3 and 4) between the cooling ridges 11, and along the length (outside) of the FC bar 1A; and within the annulus between the (outside) surface of the FC bar 1A, and the surface of the traveling anode-electrode 3. (Note, broken line 11A, indicates the surface diameter of the FC bar 1A cooling ridges 11, as it relates in proximity to the rotating anode-electrode 3 surface as seen in FIGS. 2 and 4, relative to FIG. 3). With reference to FIGS. 2, 3, 4 and 8, the said anode-electrode surface 3 is a fixed part of the rotating anode 3, electrolyte 5 and cathode 4 assembly, or (AEC) assembly 2. With particular reference to FIGS. 2, 3 and 4, the said AEC assembly 2, which includes the said anode-electrode surface 3 (and its sub surface 3A), is in high speed rotation around the stationary FC bar 1A. The pressured fuel flow (F) travels down the length of the FC bar 1A, outside the FC bar 1A, between the said cooling ridges 11, being evenly delivered and fully exposed to the accelerated hunger of the rapid rotational lapping of the high speed rotating anode-electrode surface 3, 3A which forms the inside surface area of the greater rotating AEC assembly 2. A further advantage of the (rotating) motion-movement of AEC assembly 2 (which includes the electrolyte 5, sandwiched by the anode 3, 3A, and the cathode 4, 4A, electrodes) is recognized at the anode, in that the condition of “hotspots” due to the uneven and mal-distribution of fuel is alleviated by the fully exposed and even contact of fuel achieved by the rapid rotation of the anode-electrode surface 3,3A. Further to this advantage, is that the same rotation motion-movement providing for accelerated electrochemical activity opportunity per second of operation at both the anode and cathode.

With reference to FIG. 4, at the end portion of the FC bar 1A, any excess fuel finds the return aperture inlet, not shown; however, indicated with fuel flow arrow marked (F), in FIG. 4, showing fuel (F) entering the corresponding concentric chamber 15 B, of the return manifold 1C, which directs the excess (unconsumed) fuel (F), to the fuel return chamber 16B, of the return manifold 1C, clearly shown in FIG. 6 with fuel flow arrows marked (F). FIG. 6 shows a top view of return manifold 1C, relative to FIG. 4. The return of the fuel continues through the return fuel chamber 16B of the return manifold 1C; shown in FIGS. 3 and 4; and further continues, shown in FIG. 2, indicated by fuel flow arrow marked (F) within chamber marked 16A, of the main manifold 11B; and further continues in FIG. 1, indicated by arrow marked (F), showing said fuel leaving main manifold, via exit valve 16, provided for return and recirculation of any unused fuel. The recirculation of fuel may not be necessary if pure hydrogen (being all consumable) is the reactant, or the complete oxidation of fuel is not preferred or possible. Note, chamber bore 16B of the return manifold 1C, as shown in FIGS. 4 and 6, is in direct communication through the FC bar 1A, with 16A of the main manifold 1B as shown in FIGS. 1 and 2, via bore marked 16B in FIG. 3; as 16B and 16A are opposite openings of the same bore.

As the AEC assembly 2 (more specifically, the anode-electrode 3, 3A) rotates around the stationary FC bar 1A, the cooling ridges 11 (the detailed function of which is explained further) are acting to cool the traveling surface of the anode-electrode 3, 3A serving to draw back moisture lost with proton travel carried through the polymer electrolyte membrane, or PEM 5 (FIG. 3 shows a partial view of AEC assembly 2 and its rotating relationship to the cooling ridges 11). Each proton passing through the PEM 5 carries with it multiple moisture molecules, as detailed in the summary of invention. As the anode-electrode 3 (of the AEC assembly 2) is passed over each cooling ridge 11, of the stationary FC bar 1A, heat is rapidly removed from the traveling anodic surface 3, 3A where it is generated. This rapid heat removal reduces the electroosmotic travel (moisture loss) carried from the anodic oxidation side 3, 3A to the cathodic reduction side 4, 4A of the AEC assembly 2 (as the anodic side of the membrane surface 3, 3A is maintained at a lower temperature than that of the cathodic surface side 4, 4A). The increased moisture, draw back, will serve to keep the anode side of the PEM 5 moist and functioning at the critical anode-electrode side 3,3A. This cooling is achieved by the heat exchange system disposed within the cooling ridges 11, and within the FC bar 1A, 1B and 1C; and is explained as follows:

With reference to FIG. 1, the cooling-medium having been cooled in a heat exchange system outside the fuel cell, inters the main manifold 1B, through the coolant entry valve 17, as shown in FIGS. 1 and 2. The coolant (C) following the direction of arrow marked (C) pressurizes the coolant inlet chamber 17A, and forces the coolant (C) through the coolant feed inlet apertures 20 provided in the floor of (and disposed within) the concentric chamber 17A; that lead directly into the FC bar 1A cooling ridges 11; the said inlet apertures 20 are shown in FIG. 7. The concentric construction of said chamber 17A, allows a radius of distribution inlet apertures 20, for the coolant stream (C) to enter into each of the cooling ridges 11 that extend the length (inside) of the FC bar 1A. When the coolant stream (C) passes through inlet apertures 20, the coolant stream (C) continues through the length of the FC bar 1A, to outlet aperture 20A shown in FIG. 3 (inlet apertures 20 and outlet apertures 20A are opposite openings of the same bores communicating directly through the length of each of the cooling ridges 1, of the FC bar 1A). The cooling ridges 1, of the FC bar 1A, are outlined in FIG. 7, as though seeing through the floor, from the top, of the main manifold 1B with the entry and exit valves 15, 16, 17 and 18 left out of view for clarity. In FIG. 3, the coolant bore outlet apertures 20A, are identified in FIG. 7, as inlet apertures 20; because FIG. 3, relative to FIG. 7, is shown from the opposite end of FC bar 1A.

To continue, FIG. 4, a side view relative to FIG. 3, shows a cut away of one of the cooling ridges 11, the exposed coolant bore marked 20, and an arrow marked (C) show the direction of pressured coolant flow nearing the end of the length of the FC bar 1A, to enter into the return manifold 1C. The coolant flow indicated by arrow marked (C) passes from the FC bar 1A, i.e. cooling ridges 11, through coolant bore outlet apertures 20A into the first return concentric chamber 17B, of the return manifold 1C; and as shown in FIGS. 4 and 6 with arrows marked (C), the coolant is shown flowing from said chamber 17B, into the second return concentric chamber 18 B and then into the coolant return apertures 21A, shown in FIG. 3. The said apertures 21A are provided in the ceiling (not shown in FIG. 6) of the return manifold 1C, and are concentrically disposed as to communicate from between the concentric walls of 18B, shown in FIG. 6; relative to apertures 21A, shown in FIG. 3. The warmed coolant entering the return apertures 21A, will now travel the length (inside) of the FC bar 1A (as return apertures 21A and 21 are opposite openings of the same bores communicating directly through the length of the FC bar 1A) and into the concentric chamber 18A, of the main manifold 1B, having passed through the return outlet apertures 21, as shown in FIG. 7; and as shown by arrows marked (C) in FIGS. 1 and 2; exiting main manifold 1B, via exit valve 18, as shown in FIG. 1, for heat exchange and re-cooling of coolant medium (radiator) outside the system.

It is to be understood, in a plurality of rotary fuel cell systems, such being combined in a mutual housing, that the fuel entry and exit valves 16, 17; and cooling entry and exit valves 17, 18 as described above would be appropriately inter-connected, sharing universal master entry and exit lines (not shown) that lead to and from the overall system.

FIG. 2 is a partly hatched sectional side view, taken along lines 2-2 in FIG. 3; and along lines 2-2 in FIG. 1; and along the same lines as FIG. 4. FIG. 2 shows the top portion of the single fuel cell unit, relative to FIG. 4, which shows the bottom portion. With reference to FIG. 2, the top portion of the fuel cell unit is the stationary housing support 1, and the platform for the rotary drive mechanism of each fuel cell unit, along with the fuel and cooling entry and exit system as explained above in FIG. 1. The stationary housing, sub-housing or supporting infrastructure, (or stationary structure 1), supports (in a fixed position) not only the FC bar 1A, as explained in FIG. 1, but the seated and mounted sealed bearings 7, 7A and 7B of the (rotating) motion-movement assembly 2; and the shaft bearings that seat shaft 9, shown in FIG. 10; which is the axis rotation of the drive gear 12, which engage the rotary drive mechanism as it relates to a single fuel cell unit as shown in FIG. 2 and FIG. 10; or a plurality of rotary fuel cells as exampled in FIG. 11.

The drive gear 12 rotates at its axis powered from an outside energy source, preferably electrical, off battery at start-up and or from electrical output of fuel cell (or charge) during operation. This power drag would be minimal, as rotation of even a plurality of cell units will involve little resistance; requiring little relative force to effect high speed rotation of AEC assemblies, as compared to compressor drag in prior art. However, in an alternative embodiment (perhaps most suited for larger stationary applications or less space sensitive applications of fuel cells) as illustrated in FIGS. 12 and 13, the addition of a thrust exchange propeller devise 30, 30A may be attached to each end (2B) of the AEC assembly 2 unit(s) or at any position, or multiple positions, along the length (shaft) of the AEC assembly 2 for use in an expanded (near) ambient cathodic chamber, this differing embodiment would increase drag somewhat, as referred to above, but may provide greater positive cathode performance, relative to contemporary compressor drag, cost and cathode performance in prior art; this differing embodiment will be explained further. To continue explanation of operation: the drive gear 12, as it rotates, engages the gearing 6A of the rotating receptacle 6, which is mounted on bearings 7. The stationary housing structure 1 seats the stationary outside portion 7A of said bearings 7 in the fixed position; as the rotating receptacle 6 seats the rotating inside portion 7B of said bearings 7. The bearings 7 are locked in place with locking ring, and seal (not shown) which would lock and seat at indent 8, shown in FIG. 2. The rotating receptacle 6, incorporates at its inside diameter a female threading 6B (or other reversible connecting means) in order to accommodate and receive as a connected part the male threading 2A (or other reversible connecting means) of the AEC assembly 2.

The AEC assembly 2 is shown in a hatched perspective view in FIG. 8, taken along the same lines as FIG. 2 (except for a slight tilt for perspective in FIG. 8). The AEC assembly is envisioned as a separately manufactured, replaceable and therefore a cost efficient recyclable part (for remanufacturing involving reclamation of precious metals material). The separate manufacturing of the AEC assembly 2 will offer cost and precision-quality benefits (especially with regard to PEM fuel cell technology applications) involving the intricate relationship and bonding of the various anode 3 and 3A materials; and cathode 4 and 4A materials and precious metal catalysts that will sandwich a polymer electrolyte membrane 5. With reference to FIG. 8 and FIG. 4, the AEC assembly 2 is built in a cylindrical shape having two solid structural ends. The male threaded top open end 2A; and the closed bottom end 2B; both, said end (portion) structures providing the structural strength for mounting to bearings 7B and powered rotation; and diametric-circumference support to the supporting mesh structures 3 and 4. The mesh structures 3 and 4 may act as current collectors (depending on the composition of the AEC assembly in varying applications); and therefore would require to be made from specific material; preferably material which exhibits sufficient electronic conductivity under the conditions of a given reaction while providing the structural strength of the AEC assembly 2; and permanently sandwiching the PEM from inside and outside; and resisting the swelling and or warping of the PEM 5. For example, stainless steal will offer resistance to acid corrosion and provide strength and conductivity. However, particularly with reference to the cathodic side, niobium may be preferable, as other metals may degrade due to oxygen and water proliferation at the cathode.

The reactant portion of the wall of the AEC assembly 2 is shown in FIG. 8A, in a sectional magnified view taken along the lines 8A-8A in FIG. 8. In FIG. 8A, the PEM 5 is shown larger, relative to the supporting mesh structures 4 and 3. With reference to FIG. 8A, the PEM 5 is bonded at each respective surface side: with the anode electrode 3A, at the inside surface; and the cathode electrode 4A, at the outside surface of the PEM 5. The anode mesh support structure 3, may make contact with a carbon paper (and or other such suitable material or combination thereof), not shown, which will line (or comprise) the anode electrode surface 3A, which is bonded to the anodic (inside) surface of the PEM 5. Likewise, the cathode mesh support structure 4, may make contact with a porous, wet proof graphite sheet (and or other such suitable material or combination thereof), not shown, which will line (or comprise) the cathode electrode surface 4A, which is bonded to the cathodic (outside) surface of the PEM 5. A quantity of suitable catalyst (such as platinum-black particles) may be deposited where most appropriate; for example, the structure mesh 3 and 4, may be deposited with catalyst formations at their respective surfaces and or facing the PEM 5; and or instead deposited on the respective major surfaces of the PEM 5, or respective electrode surface areas 3A and 4A.

FIG. 4 is taken along the same lines as FIG. 2 and is a side view relative to FIGS. 3 and 5. FIG. 4 shows the lower end portion of the single fuel cell unit relative to FIG. 2, which shows the top portion. With reference to FIG. 4 the lower end portion of the fuel cell comprises the return manifold 1C, much explained with reference to the fuel and cooling return concentric chambers 15B, 16B, 17B and 18B; also seen in FIG. 6 in a top view relative to FIG. 4. However, not explained as yet is the electrical components of the return manifold 1C which receive and pass electrical current from the rotating electrodes (AEC assembly 2) to the stationary FC bar 1A to be delivered outside the single fuel cell at the top portion of the FC bar 1A, which is identified as the main manifold 1B, shown in FIGS. 1 and 2.

To further explain, first with reference to FIG. 3, the fuel having been dispersed through fuel outlets 14A comes into contact with the rotating (catalyst enriched) anode electrode 3, 3A; which is a connected component of the greater rotating AEC assembly 2 (the AEC assembly 2 is shown in circumference in a perspective side view in FIG. 8; taken nearly along the same lines as FIG. 2; however, in smaller scale). The even and accelerated distribution of reactant (hydrogen) is achieved as the rotating electrode 3, 3A passes over each channel space (the oxidation area) defined between each cooling ridge 11. If hydrogen is the reactant, hydrogen supplied to the rotating anode-electrode 3, 3A is converted into hydrogen ions at the catalyst enriched surface of the rotating anode electrode 3, 3A by the loss of negatively charged electrons. In other words the (catalyst enriched) anode electrode surface 3, 3A electrochemically reacts with the hydrogen fuel (reactant) separating the hydrogen negatively charged electrons from the positively charged protons. The positively charged protons (Hydrogen ions) are drawn and move to the other side of the rotating AEC assembly 2, i.e. to the rotating catalyst enriched cathode-electrode 4, 4A through the polymer electrolyte membrane 5 (PEM 5) which must be somewhat humidified (especially at the ever drying anode side) to effectively allow this proton migration through the PEM 5. Simultaneously, the said negatively charged electrons released (from the hydrogen) during the oxidation process are drawn and move through an external circuit. This circuit leads from the anode-electrode surface 3A to the bonded member structure mesh 3 which when acting as a current collector will conduct the negatively charged electrons from the entire anode-electrode surface 3A, to the external lead circuit 23. The said lead circuit 23 begins at the conductively connected circumference-base end of the current collector mesh 3, and is from there embedded and insulated in the base wall of the end portion 2B of AEC assembly 2, as shown in FIG. 4 and magnified in FIG. 4A (FIG. 4A is taken along the same lines as FIG. 4). The negatively charged electrons (current) continues through lead circuit 23, to a high speed brush connection 24, and then to a conductive brush receiving ring track 24A which is embedded at the outside-bottom end of return manifold 1C. (The ring track 24A is shown in FIG. 5, in a view looking up at the outside-bottom end of the return manifold 1C, relative to the side view of FIG. 4). Through this brush 24 and ring 24A connection the current is transferred from the (rotating) AEC assembly 2 to the (stationary) return manifold 1C of the greater FC bar 1A. The insulated current within lead wire 23 now continues up the length of the stationary FC bar 1A, to exit at the top of main manifold 1B (shown in FIG. 2 in a side view, relative to FIG. 1, a top view of the main manifold 1B) to pass through an external circuit, providing direct electrical load. Note, in a plurality of (rotary) motion-movement fuel cell unit(s), such being combined within a housing, the current load would be appropriately wired in a joint capacity.

A complete circuit is resulted as the current returns to the fuel cell system, beginning at the circuit return lead wire 25, shown positioned at the top of main manifold 1B in FIG. 2. The insulated return current continues down the length of the FC bar 1A and to the return manifold 1C and to the conductive center track 25A which is embedded and insulated at the outside bottom end of the return manifold 1C. The said conductive center track 25A is clearly shown in FIG. 5 (FIG. 5 depicts a bottom view of the stationary return manifold 1C, looking up; relative to the side view of FIG. 4). The current continues through a high speed conductive connection 26 that is in a spinning pivotal axis connection conductively communicating with said center track 25A to pass the return current from the (stationary) return manifold 1C, to the (rotating) AEC assembly 2, more specifically to the end plate portion 2B, to follow the return circuit wiring 25 embedded and insulated within the wall of the said end plate 2B of the AEC assembly 2; to connect at the base of the rotating cathode structure mesh 4, which acts as a current dispenser over the cathode-electrode surface 4A.

Note, the mesh (grid) pattern of substrate mesh 3 and 4 are shown in FIG. 8, as having a diamond (or elongated) shape to promote a current path of the most equal resistance over the entire electrode surface areas 3A and 4A (this mesh or casing material(s) is shown much larger in FIG. 8, for purposes of depiction); however, any gauge, shape, or material of the said structure mesh or interconnect and or casing material(s) thereof 3 and 4 will be determined by the most efficient current path, material(s) and configurations, that will most efficiently collect and dispense current over the entire respective electrode surface areas 3A and 4A.

To continue, as the negative electrons (current) return and are gained at the cathode-electrode 4, 4A (the reduction area of the fuel cell system) oxygen gas or air is supplied by convection and or limited pressure PSI through air (02) entry valves 27 (depicted in FIGS. 15 and 15A) to the cathode-electrode 4, 4A through the V shaped channels formed within the cathode outer-casing wall 22 (noted as 220 in FIGS. 3, 14, 14A, 14B and 14C; and 2200 in FIGS. 12 and 13; with regard to differing embodiments of cathode chamber wall, to be explained further); the positive charged protons (hydrogen ions) having come through the said polymer electrolyte membrane 5 (PEM 5) having been gained with the negatively charged electrons (having returned from the external circuit) and having been combined with the said supplied oxygen (02) now forms by-product pure water (H20) at the cathode-electrode surface 4, 4A; and by-product heat (largely generated at the anode side); thus, completing the electrical circuit and the electrochemical reaction of the fuel cell.

The foremost advantage of the rotating AEC assembly 2 (which includes the electrolyte 5, sandwiched by the anode 3, 3A, and the cathode 4, 4A, electrodes) is recognized at the said cathode: as the centrifugal force of the rapid rotation of the cathode-electrode 4, 4A, throws off water as it forms preventing water film build up at the cathode-electrode surface 4, 4A thus preventing the crippling fuel cell condition known in prior art as “flooding” at the cathode, which prevents contact of the oxygen gas (02) with the cathode-electrode surface 4, 4A; reducing electrochemical reaction and therefore operating efficiency.

As well, with the optimal electrochemical reaction of the motion fuel cell initiated at the (rotating) motion-moving anode (including alleviating mal-distribution of fuel and resulting “hotspots”) comes the increased need to effectively remove more water, ever rapidly, at the cathode as more by-product water is being produced by the accelerated reaction at both the anode and cathode. Any cathodic heat, as opposed to anodic heat, (according to one embodiment of the invention as specifically defined in FIGS. 2, 4, 15 and 15A) is vented (forced by low capacity, minimum load and conventional air compressor system, not shown) along with any moisture vapor, through the V shape channels formed within the cathode outer casing 22; and escaping out top exit valves 28, positioned at the gravitational top of the cathode wall 22 (depicted in FIGS. 15 and 15A). Liquid water simultaneously escapes at the exit valves 29, positioned at the gravitational bottom of the cathode wall 22.

To further explain, the V shape, in the cathode wall 22, allows the by-product liquid water to collect at the deepest groove area of the V shape and to allow the said (compressed) forced air (oxygen, 02) to move along the wider area of the groove of the V shape, not only to feed oxygen to the cathode, but to catch and then carry along liquid water to the bottom valve 29 (by influence of gravity); and simultaneously, moisture vapor and heat to the top exit valve 28 (by influence of convection). It is to be understood, in a plurality of rotary motion fuel cell systems, such being combined within a mutual housing, the heat (moisture vapor) and or liquid water exit valves 28 and 29 respectively, along with the said (compressed) forced air (oxygen, 02) entry valves 27 (depicted in FIGS. 15 and 15A), would be appropriately inter-connected and will share universal master entry and exit lines to and from the system, as would the fuel and cooling explained above.

With regard to the differing embodiments of cathode chamber walls and more specifically to the differences found in FIGS. 3, 14, 14A, 14B and 14C; the cathode outer (casing) wall previously referred to as 22 in other Figs., is alternately referred to as 220. The cathode outer wall 220 (as opposed to 22) comprises V shaped channels formed running along the length of the cathode outer wall 220; rather than formed running along the diameter of the cathode outer wall 22 (as depicted in FIGS. 2, 4, 15 and 15A); this difference in cathode wall, results in the gravitational top and bottom being different; as noted by the A-B direction arrows depicted (at the right) to FIGS. 14A, 14B and 14C; and (at the right) to FIG. 15A. Each arrow marked (A) signifies the gravitational (top) up side; each arrow marked (B) indicates the gravitational (bottom) down side. Note, the said exit valves 28, 29 and oxygen (02) entry valves 27 as described and depicted in FIGS. 15 and 15A; are alternatively marked 280, 290 and 270, respectively, in FIGS. 14, 14A, 14B and 14C; although the described function of these identified entry and exit valves remain the same in each embodiment.

In another embodiment, other than the two embodiments referred to above (i.e. FIGS. 2, 4, 15 and 15A wherein the cathode wall is identified as 22; and in FIGS. 14, 14A, 14B and 14C wherein the cathode outer wall is identified as 220), a differing cathode outer wall is identified as 2200 in FIGS. 12 and 13. FIG. 12 is taken along lines 12-12 in FIG. 13; and FIG. 13 is taken along lines 13-13 in FIG. 12. This differing embodiment comprises an enlarged near ambient cathode chamber (which may prove a cost-efficiency benefit in larger stationary applications or less space sensitive applications in transportation). The addition of thrust exchange propellers 30 are attached in fixed position to the base end (2B) of the rotating AEC assembly 2, for the purpose of enhancing convection air flow throughout the cathode chamber with minimum drag; and without the use of air compressor system and or sub-systems. The propeller collar band 30A, and attached propellers 30, affix to and rotate with the AEC assembly 2, to force air, oxygen, (02) up the outside length (shaft) of the AEC assembly 2. To further explain, ambient air (oxygen, 02) is drawn into the air entry openings 2700 at the base of the cathode outer wall 2200 (shown by arrows marked (02) in FIG. 12). In this embodiment the cathode outer wall 2200 may also act as the main housing wall 1, of the greater fuel cell system. To continue, the air drawn into the said inlet openings 2700 engages the rotation of the propellers 30 (depicted in FIGS. 12 and 13) and is thrust up the shaft of the AEC assembly 2 of which the propellers 30 are a fixed rotating part, providing a constant flow of reactant (02) to the rotating surface of the cathode-electrode surface 4, 4A. The depleted air (of oxygen, 02) is now forced out by this thrust and by natural heat convection through the heat (vapor) top exit valves 2800, positioned (preferably) at the gravitational-top side of the fuel cell housing 1. The multiple heat (vapor) exit valves 2800, in this embodiment, are inter-connected by a manifold (not shown) that each exit valve 2800 may share a single exhaust manifold system. With specific reference to this embodiment (depicted in FIGS. 12 and 13), liquid water is thrown from the outer surface of the AEC assembly 2 (or more specifically the cathode-electrode 4, 4A) to be deposited through and to the other side of a non-splatter screen 31 and on to the inside of the cathode wall 2200. The liquid water now moves, by influence of gravity, down the splatter screen 31 and or down the inside of the cathode wall 2200 to the gutter tray 32, to now traverse and find the liquid flow through passages 33 allowing the liquid water to pass sheltered from the thrust of the propellers 30, 30A and into the water collecting reservoir 34 for release through the water exit valve 2900, to exit the system.

FIG. 9 depicts an example of an alternative design of the main FC bar 1A, as opposed to that shown in FIG. 3; and is taken along lines 9-9 in FIG. 10. FIG. 9 shows the main FC bar 1A in the same cross sectional view, taken along the same line of view and in the same scale as FIG. 3; the parts, inlets and outlets are marked with the same numbers as those referred in FIG. 3; as such parts, inlets and outlets correspond and function identically. However, the cooling ridges 11 differ in size, shape and number as do the size, shape and number of the various inlets and outlet bores. It should be noted the exact design and shape of the FC bar 1A, may vary greatly depending on the cooling and reactant requirements of a particular system application; the example shown in FIG. 9 is intended to show the versatility of design available within the general function of the stationary fuel and delivery bar (FC bar 1A) and within the function of the main manifold 1B. Further differing embodiments follow, involving a plurality of concentrically configured AEC assembly unit(s); including multiple disk plate and plane configurations; as well as differing modes of motion-movement, other than described continuous rotary motion-movement; which may offer some advantages over static systems.

FIG. 10 is an exploded, perspective view of the single rotary motion fuel cell unit; however, any cathode outer-casing wall 22, 220 and 2200, to be described in various cathodic embodiments, is not shown. The FC bar 1A depicted in FIG. 10 is shown hatched, exploded and in perspective reflecting the same number of cooling ridges 11 and number of inlets and outlets as that depicted in FIG. 9. The rotary motion drive mechanism, engaging a single cell unit, is shown. With reference to FIGS. 10 and 2, the powered gear 12, rotates, in axis on shaft 9 and its shaft bearings (note, said shaft bearings, that seat shaft 9 to the main stationary housing 1, are not shown in Figs.); and may be powered by a belt pulley 36 connected at the opposite end of the said shaft 9 (outside the housing 1). The said pulley 36 may be engaged by a serpentine type, high flex-speed and low resistance drive belt 35. The said drive belt 35 is engaged and driven by an electric motor, to be explained further. As the said drive gear 12, rotates as described, the gearing of the said drive gear 12 engages the gearing 6A of the rotating receptacle 6, which is internally threaded 6B and is attached in a female relationship to the threaded male end 2A of the AEC assembly 2; such providing a fixed operating connection, thereby effecting the rotation of the AEC assembly 2; and thereby the rotation function of a single rotary motion fuel cell unit.

FIG. 11 is a schematic, perspective view, exampling a plurality of rotary motion fuel cell units arrayed within a mutual housing 1 (relative to FIG. 10, portraying one such unit); and is taken along the line of view represented by broken arrow marked 11, in FIG. 10. The powered gears 12 are shown, in this particular example, in a plurality of three units that each, in turn, rotate and power a multiple of four single fuel cell units, for a total of 12 single cell units being powered for rotation within a single housing 1, in this example. Further, with reference to FIG. 11, a single belt power drive mechanism is exampled, showing how the rotation of a plurality of rotary motion fuel cell units may be achieved with a single power source; engaging a single belt 35. It may be intended, for cost performance issues, that one power source (i.e. a high speed minimum load electric motor, not shown, powered by battery at start-up of system and or by electric load output, or charge to battery, during operation) would engage a single drive belt 35 which would in turn indirectly engage and power a multiple array of fuel cell units.

It should be noted, any number or multiple array of rotating AEC assembly units may be engaged from various angles and positions for rotation, along belt(s), chain(s) or other drive mechanism(s), including extended gear shaft(s) engaging any number of gear wheel(s) along such rotating shaft(s); or combination mechanism(s) thereof; to provide for the greatest speed (or effect) for least power drag.

However, to further describe with reference to FIGS. 10, 11, 13, a single low resistant, high flex-speed drive belt 35 engages and thereby rotates any multiple number of belt pulleys 36 (outside the main housing wall 1). Each pulley 36 being in a fixed connection to (outside) end of shaft 9; and the powered gears 12, being in a fixed connection at the opposite (inside) end of shaft 9 (inside the main housing wall 1), result in rotating together in the fixed connection. The powered gears 12 (inside the main housing wall 1) in turn, engage and power a multiple number (group) of rotating receptacles 6 (note, in FIGS. 11 and 13, four rotating receptacles 6, 6A are exampled, engaged with each powered gear 12); the gearing 6A, of each rotating receptacle 6 is enmeshed with the gearing of the powered gear 12; the powered gear 12 acting as a sprocket engaging and rotating any number of rotating receptacles 6; and thereby the connected AEC assembly 2 which is operationally attached at the rotating receptacle 6 female threading 6B; within each of the single cell units.

With further reference to FIG. 13, although intended to illustrate a differing cathodic embodiment as described above, the powered gears 12 as depicted, are functionally identical and are shown in a top view (relative to FIG. 12) engaged (enmeshed) to the rotating receptacle 6 gearing 6A. Note, the rotation direction arrows marked (D) show the direction of rotation of the said powered gears 12. In addition, the belt 35 is not shown in FIGS. 13 and 12, for clarity. Further, with reference to FIG. 12, the pulleys 36 identified in FIGS. 10, 11 and 13, are not shown.

Further alternative embodiments are referenced in 3 additional drawings (numbered 4 of 6, 5 of 6 and 6 of 6) beginning with the first of these embodiments represented in drawing 4 of 6; note, from this point in the detailed descriptions, generally similar parts or parts performing similar, corresponding or identical functions as described in FIGS. 1, 2, 3, 4, 5, 6, 7, 8, 8A, 9, 10, 11, 15 and 15A of previous 3 drawings (i.e. 1 of 6, 2 of 6 and 3 of 6) are now identified with numbers which will differ from those described above by multiples of one hundred; (the first differing embodiment beginning with 400(s)). Said similar parts and or functions to each differing embodiment, if previously explained in detail, with reference to the above described rotary motion (single) cell unit, (and to any other described embodiment), if obvious, will not be repeated in the following pages; and if alternative parts and functions can be applied, it can be assumed to apply to any following differing embodiments; or in the opposite, where similar or alternative parts and or functions are detailed here and are analogous with any other differing embodiments, such can be assumed to apply to those differing embodiments as well.

Referring to drawing 4 of 6 and in particular to FIGS. 18 and 19; the following embodiment represented is a plurality of AEC assembly units 402 (including any interconnect and or casing material(s), bonded or attached thereto) being cylindrical or tubular shaped; however constructed in various diameters so as to be arranged and fixed in concentric configuration, each member shape (AEC assembly unit) 402, sharing a common radial center axis; each said member 402, fitting within the inside radius of the circumferentially larger other; and or to contain the outside radius of the circumferentially smaller other; so as allowing an annulus space between each other said member unit 402, within the concentric configuration.

In FIGS. 16, 18 and 19, a combined stationary anode and cathode reactant and cooling delivery means 401A (including by-product water (H2O) removal at the cathode 422), are disposed within each said annuals space and between each said motion-moving AEC assembly 402. The said combined stationary cooling and reactant delivery means 401A (referred to as the fuel and cooling bar (FC bar 1A) in described single cell embodiment) is supported in fixed position, between said motion-moving AEC assembly units 402, by said stationary housing, sub-housing and or infrastructure 401 (here after referred to as stationary structure 401), clearly depicted in FIG. 19. The first said combined delivery means 401A (in this embodiment) would be an elongated tubular or bar shape intimately fitted within the inside radius and extending the length of said AEC assembly 402; the second or any multiple of said combined delivery means 401A, being a cylindrical or tubular shape, would include a cathode reactant delivery 427 (including by-product water (H20) removal at the cathode 422), intimately fitted within the length and concentric radius of each annuals space of which is defined by each motion-moving cylindrical or tubular shaped unit(s) AEC assembly unit(s) 402.

The introduction of cooling medium, fuel reactant and cathode (02) reactant (including by-product water removal) to and from said combined stationary cooling and reactant delivery means 401A (here after referred to as combined delivery means 401A) is achieved through the attached concentric manifold 401B, depicted in FIG. 18, in perspective, angled away from the said stationary structure 401; and outlined in FIG. 19, with depicted arrows indicating various mediums moving in and out of the various sealed inlet and outlet apertures that lead into and out of the said combined delivery means 401A (including by-product water(H20) removal at the cathode side) of which said combined delivery means 401A, extends the length of the stationary housing 401 and the motion moving AEC assemblies 402.

FIG. 17 is taken along lines 17-17 in FIG. 18, and is a magnified cross sectional view of a portion of the concentric manifold 401B, showing the multiple plenum chambers, identified by the specific medium traveling through the inlet and outlet apertures depicted. Additionally, FIG. 17 depicts a portion of the cooling (medium) sealed tubing 417, extending radially through other concentric chambers to supply cooling medium to a multiple of concentrically positioned cooling and reactant delivery means 401A.

Not shown in FIG. 17 are the other sealed tubing(s) that extend radially through other concentric chambers to service differing mediums, in the same way; only four (out of six) of said sealed tubing(s) are partially visible in FIG. 18, due to angle of depiction.

The fuel (F) enters the said concentric chamber 401B (not shown, due to angle of depiction in FIG. 18) and pressurizes the (fuel reactant) sealed tubing 415, and accordingly each (fuel reactant) concentric chamber 442, in communication with said sealed tubing 415 (each said combined delivery means 401A, will have its own concentric chambers 442, to receive and return various mediums). With reference to FIGS. 17 and 19, the construction of each (fuel inlet) concentric chamber (identified by aperture 414, in FIG. 17) allows a radius of distribution apertures 414; for the fuel stream to enter the said combined (fuel reactant) delivery means 401A, passing through ducting to aperture opening 414A, positioned between cooling ridges 411, and within the annuals between the surface of the said combined (cooling) delivery means 401A, and the surface of the motion-moving AEC assembly 402, to communicate with anode electrode 403 (including any interconnect and or casing material(s), (not shown)). The pressurized fuel travels the length of the said combined (fuel) delivery means 401A. With reference to FIG. 19, at the opposite end portion of said combined (fuel) delivery means any excess fuel finds the return aperture inlet 416B (depicted in FIG. 16), and returns through ducting to concentric manifold through aperture 416A, to (fuel) return sealed tubing 416 (depicted in FIG. 18, and shown in FIG. 19, with arrow marked (F)), for exiting system.

Cathode reactant (02) enters the said concentric chamber 401B (not shown, due to angle of depiction in FIG. 18) and pressurizes the (cathode reactant) sealed tubing 427 (only indicated in FIG. 19) and accordingly each (cathode reactant) concentric chamber 442, in communication with said sealed tubing 427. With reference to FIGS. 17 and 19, the construction of each (cathode (02) inlet) concentric chamber (identified by aperture 427A, in FIG. 17) allows a radius of distribution apertures 427A, for the cathode reactant (02) to enter the combined (cathode reactant) delivery means 401A, passing through communicating aperture opening 427B (depicted in FIG. 16) to the V shaped channels 422, formed at cathode side of the said combined delivery means 401A, to travel between said channels communicating with cathode electrode 404 (including any interconnect and or casing material(s), not shown, of the AEC assembly 402). As the centrifugal force of the motion-movement of the cathode-electrode 404 (AEC assembly 2) throws off by-product water (H20), as it forms at the cathode-electrode surface 404; said (H20) is carried with depleted (02) reactant, finding the outlet aperture 429A (depicted in FIG. 16); through ducting to outlet aperture 229B (depicted in FIG. 17) and into (cathode reactant (02,H20)) return concentric chamber to pass into (cathode) return sealed tubing 429 (depicted in FIG. 18 and identified in FIG. 19 with arrow marked (02, H20)) for exiting system.

Cooling medium enters the said concentric chamber 401B (not shown, due to angle of depiction in FIG. 18) and pressurizes the (cooling medium) sealed tubing 417 (depicted in FIG. 18) and accordingly each (cooling medium) concentric chamber 442, in communication with said sealed tubing 417. With reference to FIGS. 17 and 19, the construction of each (cooling inlet) concentric chamber (identified by aperture 420, in FIG. 17) allows a radius of distribution apertures 420, for the cooling medium to enter the combined (cooling medium) delivery means 401A, and to pass through communicating aperture opening 420A (depicted in FIG. 16) to travel the length of the cooling ridges 411, depicted in FIGS. 16, 18 and 19. FIG. 16 shows a magnified cut away of the cooling ridges and how they relate to a plurality of concentrically configured AEC assemblies 402, and being a part of a combined delivery means 401A, as described. To continue, the coolant, identified as arrow marked (C) (depicted in FIG. 19) traveling within the sealed ridges 411, carries heat, from the anode-electrode 403, to cooling medium return aperture 421A (depicted in FIG. 16) to travel back (through sealed ducting or channeling) the length of the said combined delivery means 401A, and through outlet aperture 421 (depicted in FIG. 17) into (cooling medium) return concentric chamber, and then into (cooling medium) return sealed-tubing (not depicted in FIG. 18; however, identified in FIG. 19, with arrow marked (C)) for exiting system for heat exchange and re-cooling of medium.

With reference to FIG. 19, the said stationary structure 401, supports (in fixed position) the said combined delivery means 401A, and the seated and sealed bearing assembly, comprising 407, 407A and 407B; of which assembly, being a first part; wherein a second part (i.e. said AEC assembly 402), may have a motion-movement relative to an attached stationary third part (i.e. said stationary structure 401). The said AEC assembly units 402, or portions or connections (i.e. end plate 406), are largely supported by and or at said bearing assembly 407, 407A and 407B. Additional bearing assembly(s) 440, and at opposite 441, each, provide for a motion-moving seal between stationary structure 401, and motion-moving end portion(s) (i.e. end plate 406); and at opposite, end portion 402B (being end components of AEC assembly 402); and the separation (division) between the motion-moving AEC assembly 402, from other stationary fixed parts including said combined delivery means 401A.

It should be understood, with reference to differing configurations and or embodiments that any reference to bearing assembly(s) (and or units) be understood to also refer to any alternative part or assembly(s) of which (in place of said bearing assembly(s) 407, 407A, 407B, 440 and 441), would also act as said first part (however having a limited give and take motion-movement absorbing capability, function or quality) to allow an attached second part (i.e. said AEC assembly 402, or portion of same; or any connection(s) (i.e. end plate 406) or at opposite 402B, to said AEC assembly 402), to have described differing (give and take) motion-movement (i.e. oscillating or reciprocating motion-movement; and or a micro (or vibration) oscillating or reciprocating motion-movement), relative to an attached stationary third part (i.e. said stationary structure 401). In addition, said first part (i.e. assembly(s) 407, 407A and 407B; including 440 and 441), alternatively being a motion (or shock absorbing) mount(s), may take the form of a ring or gasket shape (assembly); having a radius to be attached, fixed, between the like radius of said second and third parts; so as providing for reactant seals between said second and third parts (particularly, in the case of said first part assembly(s) 440 and at opposite 441, dividing reactant chambers).

Said bearing assembly 407, 407A and 407B, (or otherwise supporting motion absorbing mounts); including sealed bearing assembly(s) 440 and at opposite 441, (or otherwise alternative motion absorbing mount assembly(s)), will share an axis with AEC assemblies 402. Said axis being defined as an imaginary line passing through a unified ridged body (AEC assemblies 402); dividing said body into two equal symmetrical parts; said line being the axis on which said body revolves or has a motion-movement.

With reference to FIG. 19, a single power driven mechanism providing motion-movement (not shown) is transferred to a (rotating) or powered gearing 412; of which engages receptacle gearing 406A, effecting the (rotary) motion-movement of the end plate 406, and the connected concentrically configured AEC assembly units 402. The said end plate 406, serves to hold the AEC assemblies in single fixed ridged attachment, providing the structural connectivity and strength by which is transmitted said motion-movement to AEC assemblies 402.

Each AEC assembly 402, comprising: anode-electrode 403, electrolyte 405 and cathode-electrode 404 (including any interconnect and or casing material(s) at the anode side and at the cathode side, (not shown)), are held in tightly bonded assembly (AEC assembly unit 402), structurally, by end portions 402A and at opposite by 402B; of which 402A, may contain threading or other sealed connective means to allow the removal of each said AEC assembly unit 402.

To further describe the said power driven mechanism, of which providing motion-movement (not shown), transfers motion to gearing 412, to engage receptacle gearing 406A, at any circumferential or radial point, of which said point shares axis with any rotating or oscillating motion of AEC assembly units 402 (or any motion-movement having an axis of rotation, or a definable radial arc). The said point being defined as any devise, mechanism or interactive component of moving parts through which (said point) is transmitted a motion-movement to said AEC assembly units 402. The said mechanism of moving parts may include: shaft(s), gearing(s), bearing(s), wheel(s), belt(s), pulley(s); drive chain(s) and sprocket(s), or any combination of any such.

More than one (or multiple sets) of AEC concentrically arranged pluralities 402, described above may be positioned and arranged within a larger mutual housing, and or otherwise adjacent to a supporting infrastructure (not shown); to facilitate mutual engagement to a single power driven mechanism (not shown); of which the mutual motion-movement of more than one said pluralities may be effected through a mechanism of moving parts which may include: shaft(s), gearing(s) bearing(s) wheel(s), belt(s), pulley(s), drive chain(s) and sprocket(s), (not shown). As well, the mutual communication of said AEC assembly pluralities 402, with common sources of reactant and cooling medium and exits of same; including electrical circuitry.

The circuitry as explained in first embodiment of a single cell is comparable to this embodiment; and identical with regard to AEC assembly 2 (depicted in drawing 1 of 6) electrochemical descriptions; and will not, therefore, be repeated. As with other referenced embodiments, an electrical conducting means is provided between a motion-moving circuit and a stationary circuit to communicate current there between. A motion-moving circuit 424 and 426 are depicted providing conducting to a stationary circuit 424A and 426A; via a brush or otherwise conducting means, adjacent or contiguously in contact to a ring or collar conducting means or track; extending the circumferential radius of delivery means 401A; enabling electrical communication between said stationary circuit 424A and 426A; and said motion-moving circuit 424 and 426.

At said end portions 402A, positive and negative motion-moving circuit 424 and 426 communicate to and from AEC assembly units 402 (circuit 424 and 426 is depicted as a single line for clarity) extending from said end portion 402A through insulated circuitry supported by end plate 406; and communicating current through the above described conducting means, to outside system, depicted as circuit leads 423 and 425. Said leads 423 and 425, including the other stationary component(s) of said stationary circuit 424A and 426A are supported in fixed insulated position by said stationary structure 401.

With reference to drawing 5 of 6, a further differing embodiment is depicted. Generally similar parts or parts performing similar, corresponding or identical functions will be identified with numbers which will differ from those described above by multiples of a hundred; (the following differing embodiment beginning with 500(s). Said similar parts and or functions to each differing embodiment, if previously explained in detail, with reference to any other described embodiment, if obvious, will not be repeated in the following pages; and if alternative parts and functions can be applied, it can be assumed to apply to the following embodiment; or in the opposite, where similar or alternative parts and or functions are detailed here and are analogous with any other differing embodiments, such can be assumed to apply to those differing embodiments as well.

Referring to drawing 5 of 6 and in particular to FIGS. 20 and 21; the following embodiment represented is a plurality of AEC assembly units 502 (including any interconnect and or casing material(s), bonded or attached thereto, (not depicted or indicated in drawing 5 of 6)) are constructed in a generally disk or plate shape; and are spaced, mounted (fixed) at their axis (rim) 502A, on a rotating or otherwise motion-moving axis shaft 506, to gain mutual motion-movement through common ridged attachment to said axis shaft 506. A further differing configuration (not depicted) would include AEC assembly units 502, being alternatively mounted (fixed) at their radial edge (rim) 502B, within a rotating or otherwise motion-moving cylinder and spaced therein; or to any acting structural portions of either said shaft 506, or said cylinder (not depicted or identified in drawings).

In FIGS. 20, 21 and 22, a combined stationary anode and cathode reactant and cooling delivery means 501A (including by-product water (H20) removal at the cathode 522), are disposed between and within each space defined as that between each said motion-moving disk or plate shaped AEC assembly units. The said combined stationary cooling and reactant delivery means 501A (referred as the fuel and cooling bar (FC bar 1A) in described single cell embodiment) is supported in fixed position, between said motion-moving AEC assembly units 502, by said stationary housing, sub-housing and or infrastructure 501 (here after referred to as stationary structure 501), clearly depicted in FIGS. 21 and 22. The said combined stationary cooling and reactant delivery means 501A (including water by-product removal at the cathode 522), being a disk or plate shape embodiment (clearly depicted in FIG. 20) is constructed to intimately fit within the radius and between (at least two) said motion-moving AEC assembly units 502 (i.e. anode-electrode 503, electrolyte 505 and cathode-electrode 504, including any interconnect and or casing material(s), (not shown)) as a stationary fixed member of said stationary structure 501.

The introduction of cooling medium, fuel reactant and cathode (02) reactant (including by-product water removal), to and from said combined stationary cooling and reactant delivery means 501A (here after referred to as combined delivery means 501A) is achieved through attached conduit (or tubing) 542, extending along the length of stationary structure 501. In FIG. 21, the attached conduit 542, for delivering, specifically, cooling medium to and from said combined delivery means 501A is shown. The other conduits for delivering differing mediums (i.e. reactants, and water removal) to and from the said combined delivery means 501A, in the same way, are not depicted, for clarity.

Referring to FIG. 21, multiple apertures leading directly into each said combined delivery means 501A, are depicted; showing inlet apertures 520, and outlet apertures 521, for cooling medium (C), along the length of the stationary structure 501, to service (cooling and heat exchanging means) within each combined delivery means 501A. It is in the same way that each differing medium (i.e. said reactants and by-product water removal at the cathode) enters and exits each combined delivery means 501A.

Referring to FIG. 20, and referencing cooling medium (C) as example for each other medium, at each cooling ridge 511, an additional said conduit 542, would exist for servicing the supply 520, and exiting 521, of cooling medium (C) to each cooling ridge 511 (not shown in FIG. 21, for clarity); thus providing a radius of supply and exiting around the radius-diameter of each said combined delivery means; and likewise for fuel reactant (F); and cathode reactant (02) (including by-product water (H20) removal); so marked with arrows in FIGS. 20 and 22.

With reference to FIG. 20, the fuel (F) enters the said (fuel) conduit 542 (not shown) and pressurizes said (fuel) conduit 542; and accordingly, fuel (F) enters fuel aperture (marked 514 and or (F), in FIGS. 20 and 22). The pressurized fuel now passes through said ducting (marked 514, in FIG. 22) to emerge at aperture opening 514A (depicted in FIG. 20) positioned between cooling ridges 511; and within the space between the surface of the said combined delivery means 501 (anode side), and the surface of the motion-moving AEC assembly 502, to communicate with anode-electrode 503 (including any interconnect and or casing material(s), (not shown)). With reference to FIGS. 20 and 22, at the opposite radial edge of the said combined (fuel) delivery means any excess fuel reactant finds the return aperture inlet 516B (depicted in FIG. 20 and identifiable as exiting arrow marked (F) in FIG. 22) and returns through said (fuel) return conduit 542, for exiting system.

Cathode reactant (02) enters the (cathode) conduit 542, not shown, to enter the combined (cathode reactant) delivery means 501A, through aperture 527A, depicted in FIG. 20, and with arrow marked (02), in FIGS. 20 and 22; and through ducting to emerge at aperture 527B (only visible in FIG. 22) to enter cathodic reduction chamber area, to communicate with cathode-electrode 504 (including any interconnect and or casing material(s), (not shown)), of the AEC assembly 502.

As the centrifugal force of the motion-movement of the cathode-electrode 504 (AEC assembly 502) throws off by-product water (H20), as it forms at the cathode-electrode 504, surface; said (H20) is carried with depleted (02) reactant, finding outlet aperture 529A (depicted in FIGS. 20 and 21, with arrow marked (02, H20)); and through (cathode-exiting) conduit 542, for exiting system. It should be noted that it is conceivable that the actual reduction chamber could travel with the AEC assembly 502, by way of including a sub-cathode chamber wall, or a part or portions thereof, with said motion-movement.

Cooling medium enters the (cooling medium) conduit 542, not shown, to enter the combined (cooling medium) delivery means 501A, through aperture 520, depicted in FIG. 20, and with arrow marked (C), in FIGS. 20 and 22; to travel the length of the cooling ridges 511 (depicted in FIGS. 20 and 22, with arrows marked (C)). FIG. 21 shows a perspective cutaway of the cooling ridges 511, and the combined delivery means 501A, and how they relate to a plurality of disk, plate shaped AEC assembly units. To continue, the coolant medium (C), traveling within the sealed ridges 511, carries heat, from the anode-electrode 503, side; back through the length of the said cooling ridges to cooling return aperture 521 (depicted in FIG. 20 and identifiable in FIGS. 22 and 20 with exiting arrows marked (C)); and into the (cooling medium) return conduit 542, for exiting system, for heat exchange and re-cooling of medium.

With reference to FIG. 22, the said stationary structure 501, supports (in fixed position) the said combined delivery means 501A, and the seated sealed bearing assembly, comprising 507, 507A and 507B; of which assembly being a first part; wherein a second part (i.e. said AEC assembly units 502), may have a motion-movement; relative to an attached stationary third part (i.e. said stationary structure 501). Said bearing assembly units 507, 507A and 507B, as depicted in FIG. 22, are seated at each (opposite) end of stationary structure 501, supporting said axis shaft 506, at each (opposite) end.

The AEC assembly units 502, being mounted (fixed) on axis shaft 506, are largely supported by and or at said bearing assembly unit(s) 507, 507A and 507B. Additional bearing assembly(s) 541, and at opposite, 540, each provide for motion-moving seals, between stationary structure 501 and edge (rim) portion 502B, and at opposite, axis (rim) portion 502A (being end components of AEC assembly 502); and the separation and division points between the motion-moving AEC assembly 502, from other stationary fixed parts, including the said stationary structure 501.

It should be understood, with reference to differing configurations and or embodiments that any reference to bearing assembly(s) and or unit(s), be understood to also refer to any alternative part or assembly(s) of which (in place of said bearing assembly(s)) would also act as said first part (however having a limited give and take motion-movement absorbing capability, function or quality) to allow an attached second part (i.e. said AEC assembly units 502, through axis shaft 506), to have described differing (give and take) motion-movement (i.e. oscillating or reciprocating motion-movement; and or micro (or vibration) oscillating or reciprocating motion-movement), relative to an attached stationary third part (i.e. said stationary structure 501).

In addition, said first part (i.e. assembly(s) 507, 507A and 507B; including 540 and 541), alternatively, being a motion (or shock absorbing) mount(s), may take the form of a ring or gasket shape (assembly); having a radius to be attached, fixed, between, the like radius of second and third parts; so as providing for reactant seals between said second and third parts, (particularly, in the case of said first part assembly(s) 540 and at opposite, 541, dividing reactant chambers).

Said bearing assembly(s) 507, 507A and 507B, (or otherwise supporting motion absorbing mount(s)); including seals or sealed bearing assembly(s) 540 and 541, (or otherwise alternative motion absorbing mount assembly(s)), will share an axis with disk or plate shaped AEC assembly units 502. Said axis being defined as an imaginary line passing through a unified ridged body (i.e. AEC assembly units and axis shaft 506); dividing said body into two equal symmetrical parts; said line being the axis on which said body revolves or has a motion-movement.

With reference to FIG. 22, a single power driven mechanism providing motion-movement (not shown) is transferred to a (rotating) powered gearing 512; of which engages receptacle gearing 506A, effecting the (rotary) motion-movement of the said axis shaft 506, and the connected disk or plate shaped AEC assembly(s) 502. The said axis shaft 506, serving to hold the plurality of AEC assembly(s) in single fixed ridged arrangement.

Each anode-electrode 503, electrolyte 505 and cathode-electrode 504, including any interconnect and or casing material(s), at the anode side and at the cathode side, (not shown); are held in tightly bonded assembly (502), primarily by axis-rim portion 502A and at opposite edge-rim portion 502B; of which 502A will provide (sealing) and a connective means to 506B (of the axis shaft 506), that will allow the removal of each said AEC assembly unit 502. Said end portion 502B, may provide portion of (gutter) channeling 522, facilitating cathode by-product water (H20) removal, depicted in FIG. 22.

To further describe, the said power driven mechanism, of which providing motion-movement (not shown), transfers motion to gearing 512, to engage receptacle gearing 506A, at any circumferential or radial point, of which said point shares axis with any rotating or oscillating motion of AEC assembly(s) 502, (or any motion-movement having an axis of rotation, or a definable radial arc). The said point being defined as any devise, mechanism or interactive component of moving parts through which (said point) is transmitted a motion-movement to said AEC assembly units 502. The said mechanism of moving parts may include: shaft(s), gearing(s), bearing(s), wheel(s), belt(s), pulley(s), drive chain(s) and sprocket(s), or any combination of any such.

More than one (or multiple sets) of AEC assembly pluralities, 502, described above, may be positioned and arranged within a larger mutual housing, and or adjacent to a supporting infrastructure (not shown); to facilitate mutual engagement to a single power driven mechanism (not shown); of which the mutual motion-movement of more than one said pluralities may be effected through a mechanism of moving parts which may include: shaft(s), gearing(s), bearing(s), wheel(s), belt(s), pulley(s), drive chain(s) and sprocket(s), (not shown). As well, the mutual communication of said AEC assembly pluralities 502, with common sources of reactant and cooling medium and exits of same; including electrical circuitry.

The circuitry as explained in first embodiment of a single cell is comparable to this embodiment; and identical with regard to AEC assembly 2, electrochemical descriptions, and will not therefore be repeated. As with other referenced embodiments, an electrical conducting means is provided between a motion-moving circuit and a stationary circuit to communicate current there between. A motion-moving circuit 524 and 526 are depicted in FIG. 22, providing conducting to a stationary circuit 524A and 526A; via a brush or otherwise conducting means, adjacent or contiguously in contact to a ring or collar conducting means or track; extending the circumferential radius of axis shaft 506; enabling electrical communication between said stationary circuit 524A and 526A; and said motion-moving circuit 524 and 526.

At said axis-rim portion 502A, positive and negative motion-moving circuit 524 and 526 communicate to and from AEC assembly units 502 (said circuit 524 and 526 is depicted as a single line for clarity) extending from said axis-rim portion 502A through insulated circuitry (supported by or within said axis shaft 506, or any acting structural portions, supporting AEC assembly units 502); communicating current through the above described conducting means, to outside system, depicted as circuit leads 523 and 525. Said leads 523 and 525, including the other stationary component(s) of said stationary circuit 524A are supported in fixed insulated position by said stationary structure 501.

With reference to drawing 6 of 6, further alternative or differing embodiments are depicted. Generally similar parts or parts performing similar, corresponding or identical functions will be identified with numbers which will differ from those described above by multiples of a hundred. Said similar parts and or functions to each differing embodiment, if previously explained in detail, with reference to any other described embodiment, if obvious, will not be repeated in the following pages; and if alternate parts and functions can be applied, it can be assumed to apply to the following embodiment; or in the opposite, where similar parts and or functions are detailed here and are analogous with any other differing embodiment, such can be assumed to apply to those differing embodiments as well.

Referring to drawing 6 of 6, several differing motion-movements are depicted. Differing motion-movements relating to cylindrical or tubular shaped AEC assembly units are depicted in FIGS. 25, 26, 27 and 28; further differing motion-movements pertaining to disk, plate shaped AEC assembly unit(s) are depicted in FIGS. 29, 30 and 31; and further differing motion-movements pertaining to plane shaped AEC assembly unit(s) are depicted in FIGS. 32 and 33.

FIG. 23, depicts the relationship between combined delivery means 401A and a stationary cathode wall 422, in a cylindrical or tubular shaped AEC assembly 402; as compared to FIG. 24, depicting a disk plate (or plane) shaped AEC assembly 502; and the (gutter) channeling 522, of a cathode wall (or alternatively, edge-rim portion 502B, as depicted in FIG. 22, of drawing 5 of 6).

FIG. 25, depicts a single cylindrical or tubular AEC assembly unit 2 (which may be comparable and apply to detailed descriptions of the embodiment comprising AEC assembly unit(s) 402). The arrow depicted marked (A), indicates the direction of a continuous rotary or rotating motion-movement; and further defined as a turning in one direction around a central point or axis.

FIG. 26, depicts a single cylindrical or tubular AEC assembly unit 2 (which may be comparable and apply to detailed descriptions of embodiment comprising AEC assembly unit(s) 402). The arrow depicted marked (B) indicates the direction of a continuous rotary or rotating motion-movement; and further defined as a turning in (the opposite as depicted in FIG. 25) one direction around a central point or axis.

FIG. 27, depicts an alternative motion-movement (with identifying numbers differing from those described above by multiples of a hundred); the following, differing embodiment beginning with 600(s); depicting a single cylindrical or tubular AEC assembly 602 (of which said motion-movement may be comparable and apply to detailed description of embodiment comprising AEC assembly unit(s) 2, and or 402). The arrow depicted, marked (C) indicates the direction of an oscillating motion-movement and or micro-oscillating (or vibration) motion-movement; of which said motion-movement is further defined as any rapid to and fro, occurring between at least two points of a definable radial arc.

FIG. 28, depicts a further alternative motion-movement (with identifying numbers differing from those described above by multiples of a hundred); the following, differing embodiment beginning with 700(s); depicting a single cylindrical or tubular AEC assembly 702 (which (said motion-movement) may be comparable and apply to detailed descriptions of embodiment comprising AEC assembly unit(s) 2, and or 402). The arrow depicted, marked (D) indicates the direction of a reciprocating motion-movement and or micro-reciprocating (or vibration) motion-movement; of which said motion-movement is defined as any back and forth and or up and down, or (and or) along any straight line.

FIG. 29, depicts a single disk or plate shaped AEC assembly unit 502. The arrow depicted, marked (E), indicates the direction of a continuous rotary, or rotating motion-movement; further defined as a turning in one direction, around a central point or axis.

FIG. 30, depicts a single disk or plate shaped assembly unit 502. The arrow depicted, marked (F), indicates the direction of a continuous rotary, or rotating motion-movement; further defined as a turning in (the opposite as depicted in FIG. 29) one direction, around a central point or axis.

FIG. 31, depicts an alternative motion-movement (with identifying numbers differing from those described above by multiples of a hundred); the following, differing embodiment beginning with 800(s); depicting a single disk or plate shaped AEC assembly 802 (which (said motion-movement) may be comparable and apply to detailed descriptions of embodiment comprising AEC assembly 502). The arrow depicted, marked (G) indicates the direction of an oscillating motion-movement and or micro-oscillating (or vibration) motion-movement; of which said motion-movement is defined as any rapid to and fro, occurring between at least two points of a definable radial arc.

FIG. 32, depicts a further differing motion-movement, as applied to a further differing embodiment (with identifying numbers differing from those described above by multiples of a hundred); the following, differing embodiment beginning with 900(s); depicting a portion of a single plane shaped AEC assembly unit 902 (which (said motion-movement) may be comparable and apply to detailed descriptions (following) of embodiment comprising AEC assembly unit(s) 1002). The arrow depicted, marked (H) indicates the direction of a reciprocating motion-movement and or micro-reciprocating (or vibration) motion-movement; of which said motion-movement is defined as any back and forth and or up and down, or (and or) along any straight line.

FIG. 33, depicts a further differing motion-movement, as applied to a further differing embodiment (with identifying numbers differing from those described above by multiples of a hundred); the following, differing embodiment beginning with 1000(s); depicting a portion of a single plane shaped AEC assembly 1002 (which (said motion-movement) maybe comparable and apply to detailed descriptions (following) of embodiment comprising AEC assembly unit(s) 902). The arrow depicted, marked (I) indicates the direction of a reciprocating motion-movement and or micro-reciprocating (or vibration) motion-movement; of which said motion-movement is defined as any back or forth and or up and down, or (and or) along any straight line.

FIG. 34, depicts a plane shaped AEC assembly 902, sandwiched, (encased) within and between: an anode oxidation chamber area (of which moving with motion-movement of material(s) definable as an anode); and at opposite (plane) side, a cathode reduction chamber area (of which moving with motion-movement of material(s) definable and acting as a cathode). Such an alternative configuration may be comparable and apply to detailed descriptions of embodiments comprising above described motion-movements of AEC assembly unit(s) 602, 702, 802, 902 and 1002.

In FIG. 34, the AEC assembly 902, being incased and each chamber sealed within a sub-housing identified as 901A, is structurally mounted and or supported by (and or at) motion (or shock) absorbing mount(s) 907, of which are directly or indirectly fixed to a generally stationary housing, and or (other) sub-housing and or otherwise supporting infrastructure 901 (here after referred to as stationary structure 901). Said motion absorbing mount(s) 907 (separating and dividing AEC assembly 902 motion-movement(s) from other stationary fixed parts, including said stationary structure 901), being defined as a first part, having a give and take motion absorbing quality, function or capability, on which a second part (i.e. AEC assembly 902, and sub-housing 901A), attached thereto may have said motion-movement(s) relative to an attached generally stationary third part (i.e. stationary structure 901).

With reference to FIG. 34, and any motion-movement in any other embodiment that is other than a continuous rotary or rotating motion-movement; an alternative electrical conducting means may be comprised of a single flexible or extendable electrical connection (or slacked electrical (wire) connection) disposed between a stationary circuit and a motion-moving circuit; that is other than a continuous rotating or rotary motion-movement.

It is conceivable that any of the defined said motion-movement(s) (including said micro (or vibration) motion-movement(s)) may be alternated or combined with one or more said motion-movement(s); including any resulting gyration motion-movement, (not shown).

The differing embodiments described above have been presented for purposes of illustration and description. It is not intended to be exhaustive or to limit the invention to the precise forms disclosed, as modifications and variations are possible in the light of the above. The embodiments described explain the principals, functions, intensions and practical applications, and should enable others skilled in the art to utilize the invention in various embodiments and with various modifications as are suited to the particular use contemplated. While the invention has been described with reference to details of the various illustrated embodiments, these details are not intended to limit the scope of the invention; rather, the scope of the invention is to be defined by the claims to follow.

1: In a fuel cell system, comprising at least a single cell, wherein each cell being comprised of any material acting as or intimately contributing to the activity of an electrolyte, is sandwiched by any material acting as or intimately contributing to the activity of an anode-electrode and by any material acting as or intimately contributing to the activity of an cathode-electrode, is combined with means to provide motion-movement to said electrolyte and electrodes, including any interconnect and or casing material(s), interrelated and or connected to said electrolyte and or any said electrodes.

2: In a fuel cell, wherein the said anode-electrode, electrolyte and cathode-electrode, including any interconnect and or casing material(s), interrelated and or connected to said electrolyte and or any of said electrodes, are constructed as a distinct concomitant (or bonded) assembly unit; set apart from other fixed, supporting or other moving parts, so as to be mechanically mounted and or otherwise engaged for motion-movement.

3: In a fuel cell system, wherein the said anode-electrode, electrolyte and cathode-electrode, including any interconnect and or casing material(s), and or any multiple of units thereof, is separated and divided from other stationary fixed parts, including any supporting infrastructure, housing or sub-housing(s), by bearing assembly(s); said bearing assembly(s) being defined as a first part on which an attached second part revolves or has motion-movement relative to an attached generally stationary third part.

4: In a fuel cell system, wherein said motion-moving electrolyte and electrodes, including any interconnect and or casing material(s), and or any multiple of units thereof, is structurally mounted to and or supported by (and or at) bearing assembly(s), of which directly or indirectly fixed to a stationary housing, and or sub-housing(s) and or otherwise supporting infrastructure; said bearing assembly(s) being defined as a first part (or component) on which an attached second part revolves or has motion-movement relative to an attached generally stationary third part;
(a) wherein said first part (ring shaped (sealed) bearing(s)) may serve as reactant chamber seal(s) between said second and third parts, and or reactant chambers.

5: In a fuel cell system, wherein said motion-movement of said electrolyte and electrodes, including any interconnect and or casing material(s), and or any multiple of units thereof, is relative to a stationary housing, and or sub-housing(s) and or otherwise supporting infrastructure; ‘stationary’ being defined as non moving parts relative to moving parts within said fuel cell system.

6: In a fuel cell system, wherein said motion-movement of said electrolyte and electrodes, including any interconnect and or casing material(s), and or any multiple of units thereof, is relative to a stationary means for delivering fuel reactant; ‘stationary’ being defined as none moving parts relative to moving parts within said fuel cell system.

7: In a fuel cell system, wherein said motion-movement of said electrolyte and electrodes, including any interconnect and or casing material(s), and or any multiple of units thereof, is relative to a stationary cooling delivery and heat exchanging means; ‘stationary’ being defined as none moving parts relative to moving parts within said fuel cell system.

8: In a fuel cell system, wherein said motion-movement of said electrolyte and electrodes, including any interconnect and or casing material(s), and or any multiple of units thereof, is relative to a stationary means for delivering cathode reactant and or a combination means of which would include by-product water removal; ‘stationary’ being defined as none moving parts relative to moving parts within said fuel cell system.

9: In a fuel cell system, wherein said motion-movement of said electrolyte and electrodes, including any interconnect and or casing material(s), and or any multiple of units thereof, is relative to a stationary means for communicating electrical current outside said motion-movement.

10: In a fuel cell, wherein the said motion-movement of said electrolyte and electrodes, including any interconnect and or casing material(s), and or any multiple of units thereof, is a rotary and or rotating motion-movement; of which said motion-movement is defined as a continuous turning in one direction or another around a central point or axis.

11: In a fuel cell system according to claim 10, wherein a mechanism of moving parts (i.e. shaft(s), gearing(s), bearing(s), wheel(s), belt(s), pulley(s), drive chain(s) and sprocket(s), and or any combination of any such thereof) engage, transmit and thereby effect the said continuous rotating motion-movement of (one or any number of) said anode-electrode, electrolyte and cathode-electrode, including any interconnect and or casing material(s) thereof.

12: In a fuel cell, wherein the said motion-movement of said electrolyte and electrodes, including any interconnect and or casing material(s), and any multiple of units thereof, is an oscillating motion-movement and or micro-oscillating or vibration motion-movement; of which said motion-movement is defined as any rapid to and fro, occurring between at least two points of a definable radial arc.

13: In a fuel cell system according to claim 12, wherein a mechanism of moving parts (i.e. shaft(s), gearing(s), bearing(s), wheel(s), belt(s), pulley(s), drive-chain(s) and sprocket(s), and or any combination of any such thereof) may engage, transmit and thereby effect the said oscillating motion-movement and or micro-oscillating or vibration motion-movement of (one or any number of) said, anode-electrode, electrolyte and cathode-electrode, including any interconnect and or casing material(s) thereof.

14: In a fuel cell, wherein the motion-movement of said electrolyte and electrodes, including any interconnect and or casing material(s), and any multiple of units thereof, is a reciprocating motion-movement and or a micro-reciprocating or vibration motion-movement; of which said motion-movement is defined as any back and forth and or up and down, or (and or) along any plane or straight line.

15: In a fuel cell system according to claim 14, wherein a mechanism of moving parts (i.e. shaft(s), gearing(s), bearing(s), wheel(s), belt(s), pulley(s), drive-chain(s) and sprocket(s), and or any combination of any such thereof) engage, transmit and thereby effect the said reciprocating motion-movement and or micro-reciprocation or vibration motion-movement of (one or any number of) said anode-electrode, electrolyte and cathode-electrode, including any interconnect and or casing material(s) thereof.

16: In a fuel cell system, wherein any of above defined said motion-movement(s) (including said micro or vibration motion-movement(s)) may be alternated or combined with one or more said motion-movement(s); including any resulting gyration motion-movement thereof.

17: In a fuel cell system, wherein an oscillating, reciprocating and or like said micro or vibrating motion-moving anode-electrode, electrolyte and cathode-electrode, including any interconnect and or casing material(s), and or any multiple of units thereof, is separated and divided from other stationary fixed parts, including any supporting infrastructure, housing or sub-housing(s), by motion absorbing (or shock like absorbing) mount(s); said mounts being defined as a first part having a give and take motion absorbing function or capability, on which a second part attached thereto may have said motion-movement relative to an attached generally stationary third part.

18: In a fuel cell system, wherein an oscillating, reciprocating and or like said micro or vibrating motion-moving anode-electrode, electrolyte and cathode-electrode, including any interconnect and or casing material(s), and or any multiples thereof, is structurally mounted and or supported by (and or at) said motion (or shock) absorbing mount(s) of which are directly or indirectly fixed to a generally stationary housing, and or sub-housing(s) and or otherwise supporting infrastructure; said motion absorbing mounts being defined as a first part having a give and take motion absorbing quality, function or capability, on which a second part attached thereto may have said motion-movement(s) relative to an attached generally stationary third part.

19: In a fuel cell system, wherein the structure and or form of said motion (or shock) absorbing mount(s) may resemble a ring or gasket shape, having a radius to be attached, fixed, between the like radius of said second and third parts; said motion absorbing mounts (assembly(s)) being defined as a first part having a give and take motion absorbing quality or function capability, on which a second part attached thereto may have said motion-movement relative to an attached generally stationary third part;
(a) wherein said first part (motion absorbing mount(s)) may serve as reactant chamber seal(s) between said second and third parts, and or reactant chambers.

20: In a fuel cell, wherein the thickness of a motion-moving wall comprises said anode-electrode, electrolyte and cathode-electrode, including any interconnect and or casing material(s) thereof.

21: In a fuel cell according to claim 20, wherein said motion-moving wall (i.e. anode-electrode, electrolyte and cathode-electrode, including any interconnect and or casing material(s)), divides and thereby defines two spaces comprised of an anode-oxidation area and a cathode-reduction area.

22: In a fuel cell, wherein said, anode-electrode, electrolyte and cathode-electrode, including any interconnect and or casing material(s), travels or otherwise has a motion-movement within, through (or alternatively with) a space comprised of said anode-oxidation area and said cathode-reduction area.

23: In a fuel cell system, wherein said anode-electrode, electrolyte and cathode-electrode, including any interconnect and or casing material(s), and or any multiple of said units thereof, has a motion-movement (encased) within a stationary housing, and or sub-housing(s) and or otherwise adjacent to a supporting infra-structure.

24: In a fuel cell, wherein the said motion-moving, anode-electrodes, electrolyte and cathode-electrodes, including any interconnect and or casing material(s), are constructed in a generally cylindrical or tubular shape.

25: In a fuel cell system, wherein an individual fuel cell generally cylindrical or tubular shaped comprises:
(a) a fuel reactant ducting and communication means, and coolant delivery and heat exchanging means extending over substantially the entire area juxtaposed and opposite to that of a peripheral surface area defined and acting as an anode-electrode;
(b) an anode oxidation chamber area being a definable space allowing for motion-movement of materials definable and acting as an anode, or alternatively moving with motion-movement of said materials definable and acting as an anode;
(c) a porous anode-electrode in fixed intimate-electrical contact with an electrolytic member at one side of said electrode and at the other surface side of same, exposable to fuel reactant;
(d) an electrolyte material for transporting ions between said anode and cathode;
(e) a porous cathode-electrode in fixed intimate-electrical contact with said electrolytic member at one side of said electrode and at the other surface side of same, exposable to (02 or 02 containing) reactant;
(f) a cathode reduction chamber area being a definable space allowing for motion-movement of materials definable and acting as a cathode, or alternatively moving with motion-movement of said materials definable and acting as a cathode;
(g) a cathode chamber wall providing channeling means for collecting and disposing of by-product water and for providing means for channeling (02 or 02 containing) reactant delivery and exhaust of same.

26: In a fuel cell according to claim 25, wherein:
(a) an anode, oxidation area, is defined at the inside first hollowed area of the said generally cylindrical or tubular shape;
(b) a cathode, reduction area, is defined at the peripheral outside first surface area of the same said generally cylindrical or tubular shape.

27: In a fuel cell system according to claim 25, wherein said anode-electrode, electrolyte and cathode-electrode, including any interconnect and or casing material(s), has motion-movement (and at anode-electrode side) intimately adjacent to and or juxtaposed, opposite and or parallel a stationary fuel delivery means; of which comprising ducting means introducing fuel reactant, communicating the length and circumference with any reactant surface area of said anode-electrode.

28: In a fuel cell system, wherein said anode-electrode, electrolyte and cathode-electrode, including any interconnect and or casing material(s), has a motion-movement (and at said cathode-electrode side) adjacent to and or juxtaposed, opposite and or parallel a stationary means for delivering cathode reactant and or a combination means to include by-product water removal; of which comprising channeling means extending the length and circumference of any surface reactant area of said cathode-electrode.

29: In a fuel cell system according to claim 25, wherein said anode-electrode, electrolyte and cathode-electrode, including any interconnect and or casing material(s), has a motion-movement (and at said anode electrode side) intimately adjacent to and or juxtaposed, opposite and or parallel, at least intermittently, to a stationary cooling delivery and heat exchanging means; of which comprising pressure sealed channeling (ducting) of coolant medium.

30: In a fuel cell, wherein said motion-moving anode and or cathode exposed surfaces are each superimposed (encased) with a mesh, or otherwise permeable structure, that distributes support and structural strength from the respective end or ends of the said cylindrical or tubular shape.

31: In a fuel cell according to claim 30, wherein said mesh, or otherwise permeable structure may also act as a contributing anode (and or cathode) electrode component.

32: In a fuel cell system, wherein a plurality of said motion-moving units, (i.e. anode-electrode, electrolyte and cathode electrode, including any interconnect and or casing material(s)), being generally cylindrical or tubular shapes are arranged and fixed in a concentric configuration; each said member shape (unit) sharing a common radial center axis and so fitting within the inside radius of the circumferentially larger other and or to contain the outside radius of the circumferentially smaller other so as allowing an annulus space between each other said member (unit) within the concentric configuration.

33: In a fuel cell system according to claim 32, wherein stationary anode and or cathode reactant delivery means and or cooling delivery means, and or combined anode and cathode reactant and cooling delivery means are disposed between and within each said annuals space; said annuals space defined as that between each said motion-moving unit (i.e. anode-electrode, electrolyte and cathode-electrode, including any interconnect and or casing material(s)).

34: In a fuel cell system according to claim 32, wherein said motion-moving units (i.e. anode-electrode, electrolyte and cathode-electrode, including any interconnect and or casing material(s)) thereof, being generally cylindrical or tubular shapes are each constructed in various diameters relative to each other said unit.

35: In a fuel cell system, wherein one unit, or a concentric plurality of said motion-moving units (i.e. anode-electrode, electrolyte and cathode-electrode, including any interconnect and or casing material(s)), being generally cylindrical or tubular shapes, and if arranged in said concentric configuration, each said unit sharing a common fixed rigid attachment to motion-moving end plates (or to any acting structural portion(s) of such) of which providing the structural connectivity and strength by which is transmitted said motion-movement to one unit and or said concentric plurality.

36: In a fuel cell system, wherein said motion-moving cylindrical or tubular shape(s) (i.e. anode-electrode, electrolyte and cathode-electrode, including any interconnect and or casing material(s)), and or any multiple of units thereof, being concentrically fixed in common attachment are mutually mounted and supported by bearing assembly(s) (or otherwise supporting motion absorbing mount assembly(s)) at any circumferential or radial position of which said position shares an axis with one or any combined multiple of said cylindrical or tubular shaped unit(s);
said axis being defined as an imaginary line passing through a unified rigid body dividing said body into two equal symmetrical parts; said line being the axis on which said body revolves or has a motion-movement; said body being one or more cylindrical or tubular shaped unit(s) as described above; said bearing assembly(s) (or otherwise supporting motion absorbing mount assembly(s)) being defined as a first part on which an attached second part revolves or has a motion-movement relative to an attached generally stationary third part;
(a) wherein said first part may serve as a reactant chamber seal between second and third parts.

37: In a fuel cell system, wherein one unit, or any set (plurality) of said unit(s) (i.e. anode-electrode, electrolyte and cathode-electrode, including any interconnect and or casing material(s)) of any shape, form or configuration, sharing an axis of motion-movement in common are mechanically or otherwise engaged to a power drive mechanism at any circumferential or radial point, of which said point shares said axis with one or any multiple of said units, resulting in the motion-movement of said unit(s); said ‘point’ being defined as any devise, mechanism or interactive component of parts of which is transmitted a motion-movement from a source of same to intended motion-moveable said unit(s).

38: In a fuel cell system, wherein more than one unit, or multiple sets (pluralities) of said unit(s) (i.e. anode-electrode, electrolyte and cathode-electrode, including any interconnect and or casing material(s)) of any shape, form or configuration, each said unit, or said set (plurality) of units, having an axis of motion-movement, are positioned and arranged in a parallel configuration relative and according to said axis of each said unit, or each said set (plurality) of units, within a mutual housing and or otherwise adjacent to supporting infrastructure; facilitating and comprising:
(a) mutual engagement to a single power driven mechanism of which the motion-movement of multiple units or multiple sets of any plurality of units, results;
(b) mutually providing communication with common source(s) of reactant(s) and or cooled cooling-medium and exits of same, and or electrical circuitry, outside said housing, sub-housing(s) and or otherwise supporting infrastructure.

39: In a fuel cell system, wherein multiple separate walled and sealed concentric plenum chambers act as a manifold to fuel cell unit(s), each chamber feeding and or receiving a specific medium (i.e. fuel reactant, or (and or) cooling medium, or (and or) cathode reactant or (and or) exhaust, including by-product water) through a multiple of inlet and outlet apertures radially positioned and concentrically spaced from within each said concentric chamber(s);
(a) wherein specific medium may travel from one concentric chamber to another concentric chamber via sealed tubing extending to or through other concentric chambers;
(b) wherein a larger concentric chamber may radially extend to service a multiple of concentrically positioned fuel cell units.

40: In a fuel cell system, wherein said stationary fuel delivery means comprises ducting and various radially spaced apertures providing for fuel reactant to communicate with a motion-moving anode-electrode within a definable anodic oxidation chamber area.

41: In a fuel cell system, wherein a stationary structural body, of any shape or form, which is adjacent to the motion-movement of an anode-electrode, electrolyte and cathode-electrode, including any interconnect and or casing material(s), incorporates and combines: a fuel delivery means comprising ducting, introducing fuel reactant to anode-electrode and a pressure sealed cooling-medium delivery and heat exchanging means.

42: In a fuel cell system according to claim 41, wherein a stationary housing, and or sub-housing(s) and or otherwise supporting infrastructure supports, directly or indirectly, in fixed stationary position one or any multiple of said combined stationary fuel reactant delivery means and cooling-medium delivery and heat exchanging means.

43: In a fuel cell system according to claim 25, wherein a first of multiple or otherwise only said combined stationary fuel reactant delivery and cooling delivery and heat exchanging means is an extended elongated tubular or bar shape intimately fitted within the inside radius and extending the length of said motion-moving cylindrical or tubular shaped unit (i.e. anode-electrode, electrolyte and cathode-electrode, including any interconnect and or casing material(s)).

44: In a fuel cell system according to claim 32, wherein a second or any multiple of said combined fuel reactant and cooling delivery and heat exchanging means also combines at opposite side of same a cathode reactant and by-product water waist channeling means; such combination alternatively being an extended hollow cylindrical or tubular shape intimately fitted within the length and concentric radius of each annulus space of which is defined by each said motion-moving cylindrical or tubular shaped unit(s) (i.e. anode-electrode, electrolyte and cathode-electrode, including any interconnect and or casing material(s)).

45: In a fuel cell system, wherein a stationary housing, and or sub-housing(s) and or otherwise supporting infrastructure supports, directly or indirectly, in a fixed stationary position one or any multiple of a combined cathode reactant delivery means and water exhaust channeling means.

46: In a fuel cell system, wherein said combined cathode reactant and water exhaust channeling means is generally (V) shaped grooved channels and or parallel ridges shaped within cathode wall, juxtaposed, opposite or parallel to a cylindrical or tubular shaped motion-moving cathode-electrode surface.

47: In a fuel cell system, wherein a propeller (fan) devise maybe attached and fixed to any cathode-electrode continuous rotary or rotating motion-movement to provide alternative or additional thrust-exchange within any chamber definable as a cathode-reduction area.

48: In a fuel cell system, wherein said stationary cooling delivery means comprises pressure sealed channeling of coolant-medium within a wall (of which at least partially defines the anodic-oxidation chamber area) being juxtaposed, opposite or parallel to a motion-moving anode-electrode surface.

49: In a fuel cell system according to claim 48, wherein channeling of coolant within a cooling delivery means may be formed as ridges or attached channeling or tubing disposed at surface of and or channeled within said wall defined as said cooling-medium delivery and heat exchanging means.

50: In a fuel cell system, wherein an electrical conducting means is provided between a motion-moving circuit and a stationary circuit to communicate current there between.

51: In a fuel cell system according to claim 50, wherein said electrical conducting means is comprised of a stationary component and a motion-moving component in electrical communication thereof.

52: In a fuel cell system according to claim 50, wherein said motion-moving component of said electrical conducting means has said motion-movement adjacent or contiguous to said stationary component of said electrical conducting means.

53: In a fuel cell system, wherein said electrical conducting means is comprised of a brush conductor in contact with a ring and or collar conductor enabling communication between said stationary circuit and a revolving or otherwise motion-moving circuit.

54: In a fuel cell system, wherein said electrical conducting means may be comprised of a flexible or extendable electrical connection (or slacked electrical wire connection) disposed between said stationary circuit and said motion-moving circuit; that is, other than a continuous rotating or rotary motion-movement.

55: In a fuel cell system according to 35, wherein said common fixed attachment (i.e. motion-moving end plates or any acting structural portion(s) of such) supporting one or a said concentric plurality of motion-moving electrodes in rigid connectivity, also provides substructure support for insulated circuitry to communicate electrical current with attached said electrodes; and at opposite, with said motion-moving component of said electrical conducting means.

56: In a fuel cell system, wherein a stationary housing, and or sub-housing(s) and or otherwise a supporting infrastructure supports in a fixed position (one or any multiple of) said stationary component of said electrical conducting means; for communicating electrical current with (one or any multiple of) said motion-moving component of said electrical conducting means.

57: In a fuel cell system according to claim 56, wherein a stationary housing, and or sub-housing(s) and or otherwise a supporting infrastructure provides substructure support for stationary insulated circuitry to communicate electrical current leading outside system; and at opposite, with said stationary component of said electrical conducting means.

58: In a fuel cell, wherein the said motion-moving anode-electrode, electrolyte and cathode-electrode, including any interconnect and or casing material(s), are constructed in a generally disk, plate or plane shape.

59: In a fuel cell system, wherein an individual fuel cell generally a disk, plate or plane shape comprises:
(a) a fuel reactant ducting and communication means, and coolant delivery and heat exchanging means extending over substantially the entire square area juxtaposed and opposite to that of a generally flat surface area defined and acting as an anode-electrode;
(b) an anode oxidation chamber area being a definable space allowing for motion-movement of materials definable and acting as an anode, or alternatively moving with motion-movement of materials definable as an anode;
(c) a porous anode-electrode in fixed intimate-electrical contact with an electrolytic member at one side of said electrode and at the other surface side of same, exposable to fuel reactant;
(d) an electrolytic material for transporting ions between said anode and cathode;
(e) a porous cathode-electrode in fixed intimate-electrical contact with said electrolytic member at one side of said electrode and at the other surface side of same, exposable to (02 or 02 containing) reactant;
(f) a cathode reduction chamber area being a definable space allowing for motion-movement of materials definable and acting as a cathode, or alternatively moving with motion-movement of materials definable and acting as a cathode;
(g) a cathode chamber wall, a portion of which, providing channeling means for collecting and disposing of by-product water and for providing (02 or 02 containing) reactant delivery means and exhaust of same.

60: In a fuel cell according to claim 59, wherein:
(a) an anode, oxidation area, is substantially defined at one side of a generally disk or plane shape;
(b) a cathode, reduction area, is substantially defined at opposite side of said generally disk or plane shape.

61: In a fuel cell system according to claim 59, wherein said anode-electrode, electrolyte and cathode-electrode, including any interconnect and or casing material(s), has a motion-movement (and at the said anode-electrode side) intimately adjacent to and or juxtaposed, opposite and or parallel a stationary fuel delivery means of which comprising ducting means introducing fuel reactant communicating the radius or square area of any reactant surface area of said anode-electrode.

62: In a fuel cell system, wherein said anode-electrode, electrolyte and cathode electrode, including any interconnect and or casing material(s), has a motion-movement (and at the said cathode-electrode side) adjacent to and or juxtaposed, opposite and or parallel a stationary means for delivering cathode reactant and or a combination means to include by-product water removal.

63: In a fuel cell system according to claim 59, wherein said anode-electrode, electrolyte and cathode-electrode, including any interconnect and or casing material(s), has a motion-movement (and at the anode-electrode side) intimately adjacent to and or juxtaposed, opposite and or parallel, at least intermittently, to a stationary cooling delivery and heat exchanging means; comprising pressure sealed channeling (ducting) of coolant medium.

64: In a fuel cell, wherein said motion-moving anode and cathode surfaces are each superimposed (encased) with a mesh, or otherwise permeable structure that distributes support and structured strength to or from an axis or shaft, extending to or from edges or rim portion of said disk; or alternatively, to or from edge to each other edge of a plane shaped anode-cathode surface.

65: In a fuel cell according to claim 64, wherein said mesh or otherwise permeable structure may also act as a contributing anode (and or cathode) electrode component.

66: In a fuel cell system, wherein a motion-moving plurality of said units (i.e. anode-electrode, electrolyte and cathode-electrode, including any interconnect and or casing material(s)), being disk, plate or plane shapes, are mounted (fixed) at their axis center on a rotating or otherwise motion-moving axis shaft and spaced thereon, or alternatively mounted (fixed) at their radial edge within a rotating or otherwise motion-moving cylinder and spaced therein, or to any acting structural portion(s) of either.

67: In a fuel cell system according to claim 66, wherein a stationary anode and or cathode reactant delivery means and or a cooling delivery means, and or a combined anode and cathode reactant and cooling delivery means are disposed between and within described space; said space defined as that between each said motion-moving disk, plate or plane shaped unit(s).

68: In a fuel cell system according to claim 66, wherein said motion-moving axis shaft (or alternatively said motion-moving cylinder, or acting structural portion(s) of either, thereof) supporting said plurality of said disk, plate or plane shaped unit(s), provides substructure support for insulated circuitry to communicate electrical current with attached said electrodes; and at opposite with said motion-moving component of said electrical conducting means.

69: In a fuel cell system, wherein said disk, plate or plane shape(s) (i.e. anode-electrode, electrolyte and cathode-electrode, including any interconnect and or casing material(s)), and or any multiple of units thereof, being fixed in common attachment are mutually mounted and supported by bearing assembly(s) (or otherwise motion absorbing mount assembly(s)) at any circumferential or radial position of which said position shares an axis with said disk, plate or plane shaped unit(s); said axis being defined as an imaginary line passing through a unified rigid body, dividing said body into two equal symmetrical parts; said line being the axis on which said body revolves or has a motion-movement; said body being said disk, plate or plane shaped unit(s); said bearing assembly(s) (or otherwise motion absorbing mount assembly(s)) being defined as a first part on which an attached second part revolves or has a motion-movement relative to an attached generally stationary third part.

70: In a fuel cell system, wherein at least one, or a plurality of said disk, plate or plane shaped unit(s) (i.e. anode-electrode, electrolyte and cathode-electrode, including any interconnect and or casing material(s)), being spaced, mounted (fixed) on a motion-moving axis shaft (or alternatively spaced and fixed within a motion-moving cylinder) gain mutual motion-movement through common rigid attachment to said shaft (or within said cylinder) or to any acting structural portion(s) of either.

71: In a fuel cell system, wherein a combined fuel reactant delivery, cooling delivery and heat exchanging means also combines at other side of same, a cathode reactant delivery means and by product water (H2O) removal means; such combination being a disk, plate or plane shaped embodiment, intimately fitted between (at least two) said motion-moving units (i.e. anode-electrode, electrolyte and cathode-electrode, including any interconnect and or casing material(s)), as a stationary fixed member of said housing, sub-housing and or otherwise supporting infrastructure.

72: In a fuel cell system, wherein a stationary housing, and or sub-housing(s) and or otherwise supporting infrastructure, supports directly or indirectly in a fixed stationary position one or any multiples of said combined cathode reactant delivery means, comprising ducting introducing cathode reactant to cathode-electrode(s), and water exhaust channeling means.

73: In a fuel cell system, wherein said cathode reactant and water exhaust channeling means is generally a V shape, grooved gutter (channeling) formed within cathode wall adjacent to radial edge of said cathode-electrode surface.

74: In a fuel cell, wherein any said motion-movement, alternatively, may include part or portions of a cathode chamber wall, or (and or) anode chamber wall, moving with anode-electrode, electrolyte and cathode-electrode, including any interconnect and or casing material(s) thereof.
